(19) United States
(12) Patent Application Publication
(10) Pub. No.: US 2025/0253932 A1
(43) Pub. Date: Aug. 7, 2025

(54) ANTENNA POINTING SYSTEMS AND RELATED METHODS

(71) Applicant: The Boeing Company, Arlington, VA (US)

(72) Inventors: Anthony Bessios, Marina Del Rey, CA (US); James T. Barrett, Manhattan Beach, CA (US); Ryan Lawrence, El Segundo, CA (US)

(21) Appl. No.: 18/815,152

(22) Filed: Aug. 26, 2024

Related U.S. Application Data
(60) Provisional application No. 63/550,521, filed on Feb. 6, 2024.

(51) Int. Cl. H04B 7/185

(52) U.S. Cl. CPC H04B 7/18513

(57) ABSTRACT

Antenna pointing systems and related methods are disclosed. An example apparatus includes memory; machine-readable instructions; and at least one processor circuit to be programmed by the machine-readable instructions to identify a transmission status of an antenna of a space vehicle based on telemetry data received from the space vehicle via a first ground antenna; identify a first signal strength value associated with first signals received at a second ground antenna, the first signals transmitted by the antenna of the space vehicle when a beam of the antenna of the space vehicle is at a first pointing angle; responsive to the transmission status and the first signal strength value, determine a pointing angle adjustment step to adjust the first pointing angle relative to the second ground antenna; and cause the first pointing angle to be adjusted to a second pointing angle based on the pointing angle adjustment step.

### RELATED APPLICATION

This patent claims the benefit of U.S. Provisional Patent Application No. 63/550,521, which was filed on Feb. 6, 2024. U.S. Provisional Patent Application No. 63/550,521 is hereby incorporated herein by reference in its entirety. Priority to U.S. Provisional Patent Application No. 63/550,521 is hereby claimed.

### FIELD OF THE DISCLOSURE

This disclosure relates generally to antennas and, more particularly, to antenna pointing systems and related methods.

### BACKGROUND

A space vehicle such as a satellite includes one or more antennas to transmit data to receiving antennas on the ground. During orbit, an orientation of the space vehicle and, thus, the space vehicle antenna, relative to a ground antenna can change, which can affect (e.g., disrupt, weaken) transmission and receipt of signals between the space vehicle antenna and the ground antenna.

### BRIEF DESCRIPTION OF THE DRAWINGS

FIG. 1 illustrates an example system including a first ground antenna, a second ground antenna, a space vehicle including one or more antennas, and antenna pointing control circuitry to control alignment between an antenna of the space vehicle and the second ground antenna.

FIG. 2 is a block diagram of an example implementation of the antenna pointing control circuitry of FIG. 1.

FIG. 3 is a state transition diagram of example system states that are identified by the antenna pointing control circuitry of FIG. 2.

FIGS. 4A-4F are block diagrams illustrating an example repointing algorithm executed by the antenna pointing control circuitry of FIG. 2 to adjust a pointing angle of a beam of the antenna of the space vehicle.

FIGS. 4G-4I illustrate example radiation pattern graphs.

FIG. 5A is a block diagram illustrating example conditions identified by the antenna pointing control circuitry of FIG. 2 in connection with controlling a pointing angle of a beam of the antenna of the space vehicle and example signal flows between the space vehicle, the ground antennas, and the antenna pointing control circuitry in response to the identified conditions.

FIG. 5B is a block diagram illustrating example communication pathways between the space vehicle and ground.

FIG. 5C is a block diagram illustrating example logic implemented by the antenna pointing control circuitry of FIG. 2 in connection with controlling a pointing angle of a beam of the antenna of the space vehicle.

FIGS. 6-8 are flowcharts representative of example machine readable instructions and/or example operations that may be executed, instantiated, and/or performed by example programmable circuitry to implement the antenna pointing control circuitry of FIG. 2.

FIG. 9 is a block diagram of an example processing platform including programmable circuitry structured to execute, instantiate, and/or perform the example machine readable instructions and/or perform the example operations of FIGS. 6-8 to implement the antenna pointing control circuitry 124 of FIG. 2.

FIG. 10 is a block diagram of an example implementation of the programmable circuitry of FIG. 9.

FIG. 11 is a block diagram of another example implementation of the programmable circuitry of FIG. 9.

In general, the same reference numbers will be used throughout the drawing(s) and accompanying written description to refer to the same or like parts. The figures are not necessarily to scale.

### DETAILED DESCRIPTION

A space vehicle such as a satellite includes one or more antennas to transmit data to receiving antennas on the ground. To facilitate transmission of data between an antenna of the space vehicle and a ground antenna, the pointing angles of the beams of the space vehicle antenna and the ground antenna should be aligned. However, during orbit, an orientation of the space vehicle and, thus, the space vehicle antenna, relative to the ground antenna can change. In some instances, the orientation of the space vehicle antenna relative to the ground antenna can change due to a motor (e.g., a gimbal motor) that controls the space vehicle antenna (e.g., antenna orientation changes due to inconsistences or inaccuracies in performance of the motor). Such changes in the orientation of the space vehicle antenna relative to the ground antenna can affect the alignment between the two antennas and, thus, affect (e.g., disrupt, weaken) transmission and receipt of signals between the space vehicle antenna and the ground antenna. In some instances, the ground antenna can track (e.g., automatically track) signals from the space vehicle antenna and adjust a pointing angle of its beam to maintain alignment with the space vehicle antenna. However, the space vehicle antenna may not include such autonomous tracking capabilities. Thus, an open loop is created, as the space vehicle antenna may not recognize that its beam pointing angle should be adjusted to maintain alignment with the ground antenna location. Further, human input to detect and address such alignment issues consumes resources such as time and, therefore, costs.

Disclosed herein are example systems, apparatus, and methods to control a beam pointing angle of an antenna of a space vehicle relative to a boresight of the antenna to facilitate alignment between respective boresights of the space vehicle antenna and a ground antenna (e.g., to align the boresight of the space vehicle antenna and a line of sight between the space vehicle antenna and the ground antenna). Example space vehicles include a first or hemispherical antenna (i.e., an antenna whose pointing direction does not depend on the orientation of the space vehicle such as telemetry tracking and commanding (TTC) antenna, such as an omni-directional antenna or a semi-omni directional antenna with a hemispherical radiation pattern) and a second (e.g., high gain) antenna with a beam pointing angle controlled by, for instance, an antenna pointing mechanism such as a gimbal. In some examples, the second antenna includes a patch antenna, where the pointing angle of the patch antenna is based on the attitude of the space vehicle and can be adjusted by controlling the attitude of the space vehicle via a guidance, navigation, and control (GNC) system of the space vehicle. Examples disclosed herein analyze telemetry downlink data transmitted by the first or hemispherical antenna (which can include semi-omni patch antenna having a hemispherical radiation pattern, where a pair of hemispherical pattern patch antennas placed on opposite panels creates omni directionality) of the space vehicle and received at a first ground antenna (e.g., a TTC antenna). Based on conditions as reported by the telemetry data, examples disclosed herein determine a transmission activity status of the second (e.g., high gain (gimbaled or electrically steerable) or low gain (body fixed) patch) antenna of the space vehicle. Examples disclosed herein also analyze power levels of signals received at a second ground antenna (e.g., a mission ground antenna), where the signals are transmitted by the high gain steerable (electrically steerable, mechanically gimbaled) antenna or the patch antenna of the space vehicle.

Examples disclosed herein analyze the two variables, namely, (a) the transmission activity status indicating whether or not the gimbaled or patch antenna of the space vehicle is transmitting (or has transmitted, or will transmit) data and (b) the power levels of the signals received at ground antenna. The use of the transmission activity status provides for increased confidence in whether data is present in, for example, a noisy signal. Based on the analysis of the variables, examples disclosed herein determine whether a pointing offset of a pointing angle of a beam of the gimbaled or patch antenna of the space vehicle relative to the antenna's boresight satisfies an angular threshold (referred to herein as a link margin angle, where “link” refers to a signal strength level to provide for reception of signal(s) transmitted by the space vehicle at the ground antenna). As used herein, pointing offset refers to an offset angle between a space vehicle antenna's boresight from a line of sight connecting the space vehicle antenna with a corresponding ground antenna when the space vehicle antenna and the ground antenna are pointing towards each other. Examples disclosed herein seek to align the space vehicle's antenna boresight axis with the ground antenna's boresight axis. As used herein, a boresight of a directional antenna refers to an axis of the antenna that exhibits the highest gain, which results in maximum radiated power. In examples herein, the terms “boresight” and “boresight axis” will be used interchangeably.

Based on the comparison of the pointing offset to the angular threshold, examples disclosed herein determine whether or not adjustment of the beam pointing angle of the space vehicle antenna (e.g., a gimbaled antenna, a patch antenna) is warranted. If the pointing offset of the beam pointing angle of the space vehicle antenna (e.g., the gimbaled or patch antenna) from its boresight axis fails to satisfy the link margin angle, examples disclosed herein determine a pointing angle adjustment step to adjust (e.g., correct) the pointing angle of the space vehicle antenna) so that the pointing offset satisfies the angular threshold. Some examples disclosed herein use iterative adjustments to refine the beam pointing angle of the gimbaled antenna to maximize power levels of signals received at the (e.g., mission) ground antenna.

Thus, examples disclosed herein define a closed control loop between a hemispherical antenna (e.g., TTC antenna) of the space vehicle, a first antenna (e.g., TTC antenna) at the ground, a second ground antenna (e.g., a mission ground antenna), and the gimbaled or patch antenna of the space vehicle to facilitate alignment between the second ground antenna and the gimbaled antenna of the space vehicle. Examples disclosed herein can monitor changes in the transmission status of the gimbaled antenna and/or the signal strength of the signals received at the (e.g., mission) ground antenna to determine whether further alignment adjustments should be performed in view of, for example, changes in orientation of the space vehicle or due to errors in estimation of a satellite locations by an orbital (space vehicle) propagator in the absence of GPS (global position system) data. Thus, examples disclosed herein provide for auto-tracking with respect to adjusting the beam pointing angle. Examples disclosed herein further detect interference in signal transmission and receipt and spectrum management policies or other airspace rules when managing the antenna alignment. Examples disclosed herein autonomously adjust the beam pointing angle of the space vehicle antenna to provide for efficient control of alignment between a space vehicle antenna and a ground antenna and maximize signal power at the receiving ground antenna.

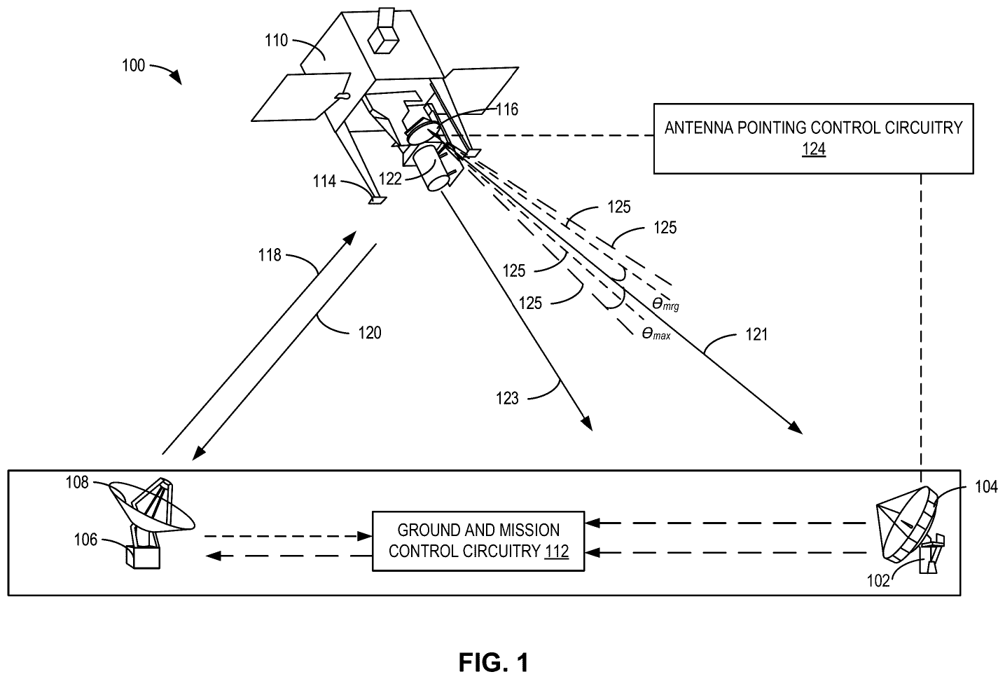

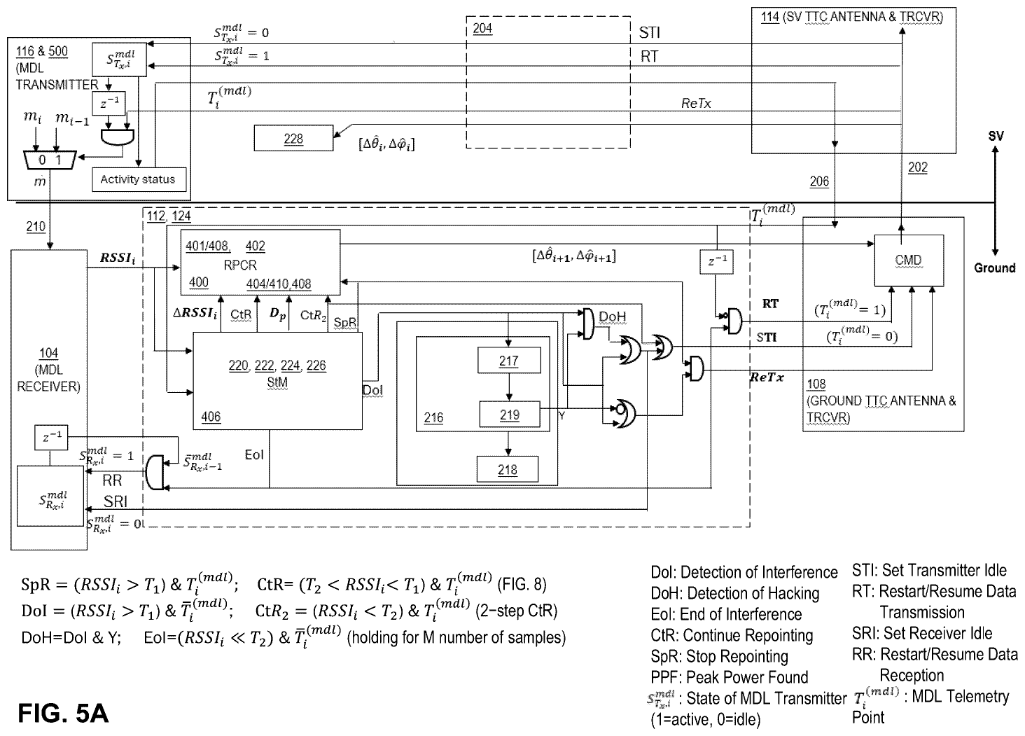

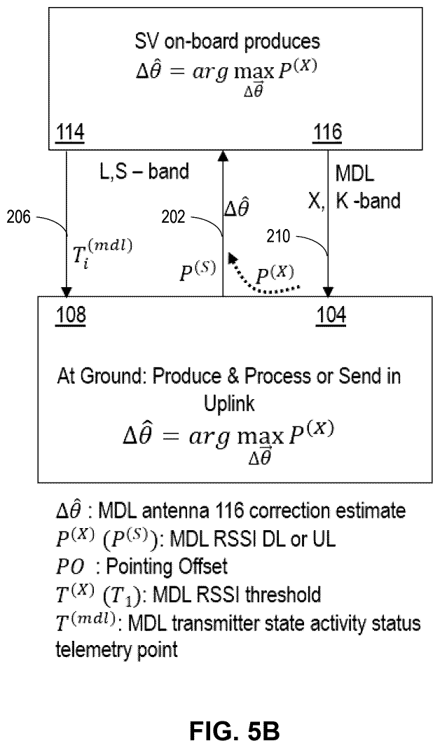

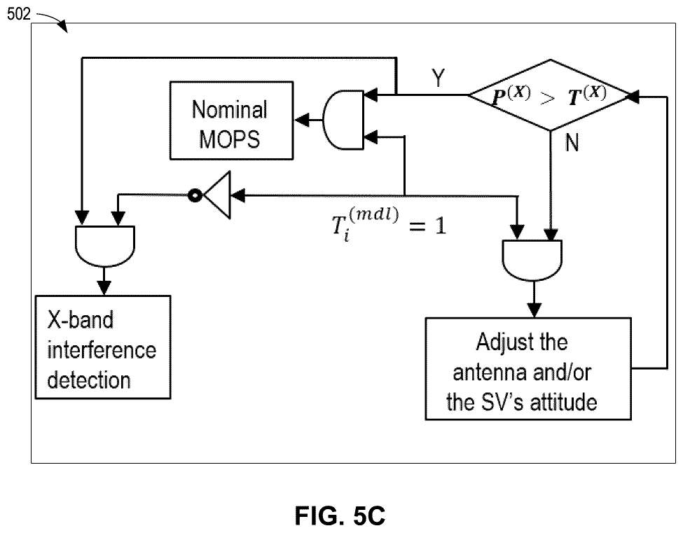

FIG. 1 illustrates an example system 100 including an example mission ground station 102 (e.g., ground entry point) including a mission ground station antenna 104 (e.g., a reflector antenna). Also, at ground, the example system 100 includes a telemetry tracking and commanding (TTC) ground station 106 including a TTC ground station antenna 108. The TTC ground station antenna 108 can include a transceiver (FIG. 5A). In the example system 100, a space vehicle 110 is in geosynchronous (GEO) orbit, low Earth orbit (LEO), or medium Earth orbit (MEO). The space vehicle 110 is in communication with the mission ground station antenna 104 and the TTC ground station antenna 108 to enable the space vehicle 110 to transmit data to and/or receive data from the ground. The space vehicle 110 can be, for example, a satellite. Personnel at, for instance, mission operations center(s) located in an environment including the mission ground station 102 and the TTC ground station 106 can control the space vehicle 110 using commands transmitted to the space vehicle 110 via the TTC ground station antenna 108. The example system 100 includes ground and mission control circuitry 112 to generate instructions that are transmitted to the space vehicle 110 via the TTC ground station antenna 108. The commands can be generated in response to, for example, data received from the space vehicle 110 via the mission ground station antenna 104 and/or the TTC ground station antenna 108.

The example space vehicle 110 of FIG. 1 includes a first antenna 114 and a second antenna 116. In the example of FIG. 1, the first antenna 114 is a hemispherical antenna (e.g., a hemispherical radiation pattern patch antenna) and, thus, not dependent on the orientation of the space vehicle with respect emitting or receiving signals from the ground. The first antenna 114 can include a transceiver (FIG. 5A). As represented by arrow 118 in FIG. 1, the TTC ground station antenna 108 transmits data (e.g., commands) to the space vehicle 110 that is received by the first, or hemispherical antenna 114 of the space vehicle 110. As represented by arrow 120 in FIG. 1, the first antenna 114 transmits data generated at the space vehicle 110 that is received by the TTC ground station antenna 108. The data generated at the space vehicle 110 includes telemetry data, state of health data, etc. Thus, the TTC ground station antenna 108 is a transceiver that transmits data to and receives data from the space vehicle 110. The first antenna 114 of the space vehicle 110 serves as a transceiver that receives commands from the TTC ground station antenna 108 and transmits data to the ground via the TTC ground station antenna 108. In examples in which the second antenna 116 includes a transceiver, then commands can be transmitted via the mission ground station antenna 104 directly to the second antenna 116.

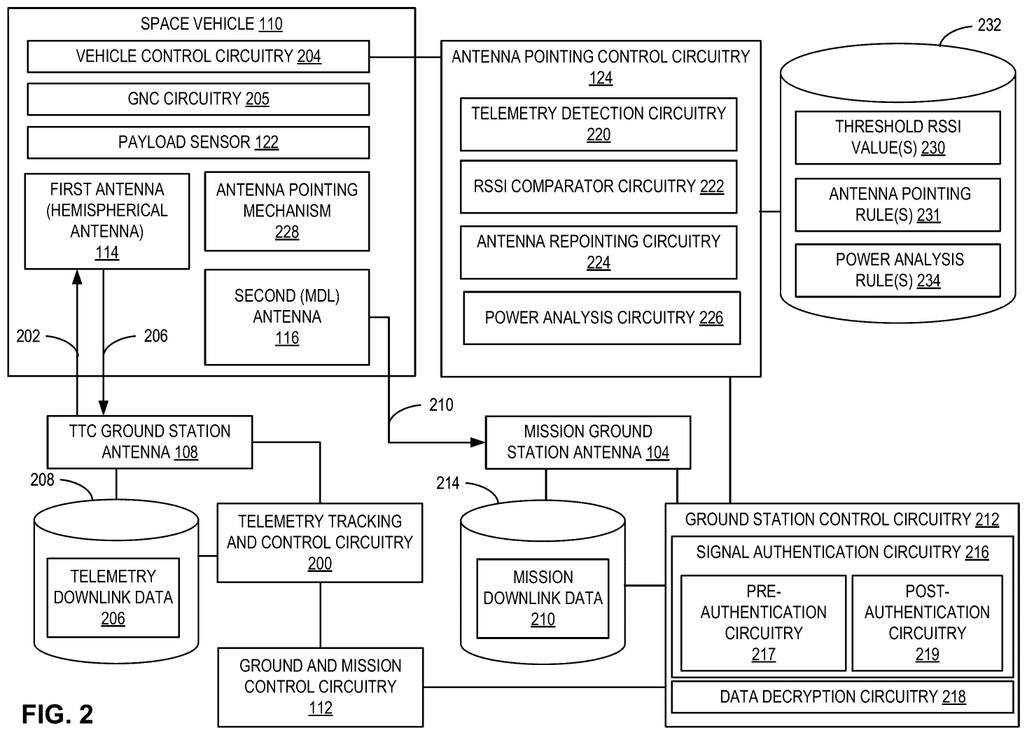

The second antenna 116 of the example space vehicle 110 is a hi-gain directional antenna. In contrast to the hemispherical first antenna 114 of FIG. 1, a pointing angle of the example second antenna 116 of FIG. 1 can be affected by the orientation of the space vehicle 110. In some examples, the second antenna 116 is supported by an antenna pointing mechanism 228 (FIG. 2). The antenna pointing mechanism can include a gimbal that can be, for example, mechanically steered. In some examples, the second antenna 116 can be electrically steered. Other types of antenna pointing mechanisms can be used. In some examples, the second antenna 116 is a patch antenna. In such examples, the pointing angle of the second antenna 116 is based on the attitude of the space vehicle 110 and can be adjusted by controlling the attitude of the space vehicle 110 via a guidance, navigation, and control (GNC) system (FIG. 2) of the space vehicle 110.

The second antenna 116 emits a beam to transmit signals corresponding to data generated at the space vehicle 110 to the ground. In the example of FIG. 1, the second antenna 116 transmits data associated with a mission being performed by the space vehicle 110, such as image data. Thus, for example purposes, the second antenna 116 will be referred to herein as the mission downlink (MDL) antenna 116. In some examples, the second antenna 116 transmits state of health data and telemetry data in addition or in alternative to the mission data. In the example of FIG. 1, the second antenna 116 (i.e., a mission downlink transmitter associated with the second antenna 116, FIG. 5A) is orientated toward the mission ground station antenna 104 (i.e., a mission downlink receiver) such that the mission ground station antenna 104 receives the data (e.g., mission data) transmitted by the second or MDL antenna 116.

The example space vehicle 110 can include other antennas in addition to the hemispherical antenna 114 and the gimbaled antenna 116. Also, the example space vehicle 110 of FIG. 1 includes a payload sensor 122. In some examples, a boresight 123 or direction of peak gain (e.g., maximum radiation) associated with the payload sensor 122 is different than the boresight of the gimbaled or patch antenna 116, as shown in FIG. 1. The payload sensor 122 can be located at other locations on the space vehicle than shown in FIG. 1. In some examples, data from the payload sensor 122 can be obtained simultaneously or substantially simultaneously as mission downlink data from the second or MDL antenna 116. In other examples, data from the payload sensor 122 and the MDL antenna 116 is obtained sequentially.

To facilitate signal transmission (e.g., high quality signal transmission) between the MDL antenna 116 and the mission ground station antenna 104, the beam of the MDL antenna 116 should be angled relative to a boresight axis 121 (also referred to herein as the boresight 121) of the MDL antenna 116 such that there is less than a threshold difference or pointing offset of the beam pointing angle from the boresight 121 (i.e., the axis of maximum gain). As a result, the pointing angle of the beam of the MDL antenna 116 points or tracks (or substantially points or tracks) towards the corresponding ground antenna 104 (e.g., in an effort to obtain alignment or substantial alignment between the boresight axis 121 of the MDL antenna 116 and the boresight axis of the mission ground station antenna 104). Put another way, a boresight of the MDL antenna 116 is aligned or substantially aligned with a line of sight between the space vehicle MDL antenna 116 and the ground antenna 104. For example, the threshold can define that there should be less than a 0.1° difference in a pointing offset of a pointing angle of the beam of the MDL antenna 116 relative to the boresight axis 121 of the MDL antenna 116. In some examples, the space vehicle 110 moves during orbit, which causes the pointing offset of the beam pointing angle of the MDL antenna 116 from its boresight 121 to change, as represented by dashed lines 125 in FIG. 1. In some such examples, the pointing offset exceeds the threshold. Examples disclosed herein seek to align or substantially align the boresight 121 of the MDL antenna 116 with the line-of-sight extending between the MDL antenna 116 and the mission ground station antenna 104 so that any pointing offset satisfies the threshold.

The example system 100 of FIG. 1 includes antenna pointing control circuitry 124 to determine whether the beam pointing angle (sometimes referred to herein as “the pointing angle”) of the gimbaled antenna 116 should be adjusted so that the pointing offset of the pointing angle of the gimbaled antenna 116 from its boresight 121 satisfies the threshold. In examples in which the space vehicle 110 includes a patch antenna, the antenna pointing control circuitry 124 determines if the attitude of the space vehicle 110 should be adjusted so that the pointing offset of pointing angle of the patch antenna 116 relative to its boresight 121 satisfies the threshold. Global Positioning System Receivers (GPSR) such as Global Navigation Satellite System (GNSS) receivers and GPS antennas provide location while star trackers provide attitude determination. Guidance, navigation, and control (GNC) circuitry 205 (FIG. 2) of the space vehicle 110 adjusts the attitude based on parameters for the mission as calculated by the ground and mission control circuitry 112. The antenna pointing control circuitry 124 (e.g., hardware, firmware, and/or software) can be implemented at the mission ground station 102 (e.g., processor circuitry located at the ground station) or at the space vehicle 110 (e.g., processor circuitry of the space vehicle 110). In some examples, one or more components of the antenna pointing control circuitry 124 are implemented at the mission ground station 102 and one or more components of the antenna pointing control circuitry 124 are implemented at the space vehicle 110.

As shown in FIG. 1, the pointing angle of the MDL antenna 116 can be defined relative to a link margin angle θ_{mrg}. When the beam pointing offset (PO) of the pointing angle of the MDL antenna 116 relative to its boresight axis 121 is less than or equal to the link margin angle (i.e., PO≤θ_{mrg}), the antenna pointing control circuitry 124 determines that the repointing of the MDL antenna 116 is not warranted. When the pointing offset exceeds the link margin angle (PO≥θ_{mrg}), the antenna pointing control circuitry 124 determines that the repointing of the MDL antenna 116 is warranted. In response and as disclosed herein, the antenna pointing control circuitry 124 executes a first repointing operation to bring the pointing offset at or below the link margin angle (i.e., PO≤θ_{mrg}). The link margin angle θ_{mrg} represents a first angular threshold.

In some examples, the antenna pointing control circuitry 124 determines that the pointing offset of the beam pointing angle of the MDL antenna 116 relative to its boresight 121 exceeds a maximum off-pointed angle θₘₐₓ (i.e., PO>θₘₐₓ), or a second angular threshold. The maximum off-pointed angle θₘₐₓ represents an angle that, when exceeded, indicates that the beam pointing angle of the MDL antenna 116 (e.g., a gimbaled antenna or a patch antenna) is in violation of spectrum management policies or other space governance rules. In such examples, the antenna pointing control circuitry 124 executes a second repointing operation (e.g., based on star tracker vehicle data and calibration data such as computed dish boresight pointing and offset relative to the mission ground station 104) to bring the pointing offset below the maximum off-pointed angle (i.e., PO≤θₘₐₓ). As disclosed herein, the antenna pointing control circuitry 124 then executes the first repointing operation to adjust the pointing angle of the MDL antenna 116 to further cause the pointing offset to satisfy the link margin angle (i.e., PO≤θ_{mrg}).

The antenna pointing control circuitry 124 analyzes (a) signals received at the TTC ground station antenna 108 (i.e., signals transmitted by the first antenna 114 of the space vehicle 110) and (b) signals received at the mission ground station antenna 104 (i.e., signals transmitted by the second or MDL antenna 116). Based on the signal analysis, the antenna pointing control circuitry 124 determines whether the beam pointing angle of the MDL antenna 116 of the space vehicle 110 should be adjusted. In particular, the antenna pointing control circuitry 124 determines (a) whether the TTC ground station antenna 108 has received telemetry data from the first antenna 114 (i.e., the hemispherical antenna) of the space vehicle 110 indicating that the MDL antenna 116 is transmitting data and (b) whether a Received Signal Strength Indicator (RSSI) (e.g., power level, signal strength) of the signals received by the mission ground station antenna 104 from the MDL antenna 116 of the space vehicle 110 satisfies threshold RSSI value(s). Based on the transmission activity status of the MDL antenna 116 as indicated in the telemetry data received at the TTC ground station antenna 108 and the analysis of the RSSI of signals received by the mission ground station antenna 104, the antenna pointing control circuitry 124 determines whether the pointing angle of the MDL antenna 116 should be adjusted to satisfy the link margin angle θ_{mrg}. In examples in which the antenna pointing control circuitry 124 determines that the pointing angle should be adjusted, the antenna pointing control circuitry 124 outputs instructions to cause the pointing angle of the MDL antenna 116 to be adjusted via movement of the antenna pointing mechanism (e.g., a gimbal) or via adjustments to the attitude of the space vehicle 110 by the GNC circuitry 205 (FIG. 2) (e.g., in examples in which the MDL antenna 116 is a patch antenna).

Although in the examples disclosed herein the mission ground station antenna 104 and the TTC ground station antenna 108 are discussed as being located at the ground, one or more of the antenna 104 or the antenna 108 could be carried by one or more other space vehicles different than the space vehicle 110. In some examples, the antenna 104 and the antenna 108 are carried by a second space vehicle separate from the space vehicle 110. In some examples, the antenna 104 is carried by a second space vehicle and the antenna 108 is carried by a third space vehicle. In some examples, the location of the antenna 104 and/or the antenna 108 on space vehicle(s) different than the space vehicle 110 can address ground-based atmospheric variations and/or signal uncertainties.

FIG. 2 is a block diagram of the example system 100 of FIG. 1 and, in particular, includes a block diagram of an example implementation of the antenna pointing control circuitry 124 of FIG. 1 to control a beam pointing angle of the MDL antenna 116 of the space vehicle 110 of FIG. 1 to facilitate signal transmission between the MDL antenna 116 and the mission ground station antenna 104 of FIG. 1. The antenna pointing control circuitry 124 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the antenna pointing control circuitry 124 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

As shown in FIG. 2, the TTC ground station antenna 108 is in communication with telemetry tracking and commanding (TTC) circuitry 200 (e.g., hardware, software, and/or firmware implemented at the TTC ground station 106). The TTC circuitry 200 is in communication with the ground and mission control circuitry 112 to receive instructions with respect to, for instance, commands to be transmitted to the space vehicle 110. The TTC circuitry 200 outputs command uplink data 202 to be sent to the space vehicle 110 in the form of signals transmitted via the TTC ground station antenna 108. The command uplink data 202 is received by the first, or hemispherical antenna 114 of the space vehicle 110.

The space vehicle 110 of FIG. 2 includes vehicle control circuitry 204 to analyze the command uplink data 202 and to generate instructions based on the command uplink data 202 to control the space vehicle 110. The example space vehicle 110 of FIG. 2 includes guidance, navigation, and control (GNC) circuitry 205 to control, for example, travel paths, location, velocity, and attitude of the space vehicle 110. The GNC circuitry 205 can control movement and/or orientation of the space vehicle 110 based on instructions from the vehicle control circuitry 204, where the instructions are based on the command uplink data 202.

In the example of FIG. 2, the vehicle control circuitry 204 of the space vehicle 110 generates and outputs signals corresponding to telemetry downlink data 206 for transmission to ground. The telemetry downlink data 206 can include, for instance, information about status and health of components of the space vehicle 110. In the example of FIG. 2, the telemetry downlink data 206 includes status information regarding transmission activity of the second, or MDL antenna 116 (e.g., a gimbaled antenna, a patch antenna) of the space vehicle 110. For example, the telemetry downlink data 206 indicates whether the MDL antenna 116 is transmitting or has transmitted data for receipt by the mission ground station antenna 104. In particular, the transmission activity status of the MDL antenna 116 included in the telemetry downlink data 206 can indicate whether the MDL antenna 116 is transmitting mission data or has transmitted mission data within a certain period of time (e.g., within the past two seconds, within the past five seconds).

The telemetry downlink data 206 is transmitted by the first antenna 114 of the space vehicle 110 and received at the ground by the TTC ground station antenna 108. The telemetry downlink data 206 received from the space vehicle 110 by the TTC ground station antenna 108 is stored in a TTC ground station database 208. The TTC ground station database 208 is accessible by the TTC circuitry 200. The example TTC ground station database 208 of FIG. 2 is implemented by any memory, storage device and/or storage disc for storing data such as, for example, flash memory, magnetic media, optical media, solid state memory, hard drive(s), etc. Although in the illustrated example, the example TTC ground station database 208 is illustrated as a single device, the example TTC ground station database 208 and/or any other data storage devices described herein may be implemented by any number and/or type(s) of memories.

As disclosed in connection with FIG. 1, during orbit of the space vehicle 110, the vehicle control circuitry 204 generates data associated with a mission performed by the space vehicle 110, or mission downlink data 210. The mission downlink data 210 can include, for instance, images collected by the space vehicle 110 during orbit. The MDL antenna 116 transmits the mission downlink data 210, which is received by the mission ground station antenna 104.

In the example of FIG. 2, the mission downlink data 210 received by the mission ground station antenna 104 is stored in a mission ground station database 214 and processed by ground station control circuitry 212 (e.g., hardware, software, and/or firmware implemented at the mission ground station 102 of FIG. 1). The example mission ground station database 214 of FIG. 2 is implemented by any memory, storage device and/or storage disc for storing data such as, for example, flash memory, magnetic media, optical media, solid state memory, hard drive(s), etc. In some examples, the TTC ground station database 208 and the mission ground station database 214 are the same database.

In the example of FIG. 2, the ground station control circuitry 212 includes signal authentication circuitry 216 (e.g., hardware, software, and/or firmware) and data decryption circuitry 218 (e.g., hardware, software, and/or firmware). The signal authentication circuitry 216 verifies that the data detected by the mission ground station antenna 104 was received from the space vehicle 110 and not another source (e.g., another space vehicle, a hacker). For example, pre-authentication circuitry 217 of the signal authentication circuitry 216 verifies that the data corresponds to mission downlink data 210 from the space vehicle (i.e., is valid and not interference). If the pre-authentication circuitry 217 verifies that the data includes authenticated messages from the space vehicle 110, then the pre-authentication circuitry 217 instructs post-authentication circuitry 219 of the signal authentication circuitry 216 to perform signal authentication using, for example, CRC (cyclic redundancy check) protocols. If the post-authentication circuitry 219 authenticates the received signal, then the data decryption circuitry 218 decrypts the data (e.g., the mission downlink data 210). The decrypted data (e.g., the decrypted mission downlink data 210) can be transmitted to, for example, the ground and mission control circuitry 112 for analysis. In some examples in which the pre-authentication circuitry 217 does not authenticate the data as generated by the space vehicle 110, the pre-authentication circuitry 217 communicates with the ground station control circuitry 212 to turn off the reception of data by the mission ground station antenna 104 to prevent jamming, to avoid interference, and/or to prevent hackers from accessing data associated with the ground station control circuitry 212, the telemetry tracking and commanding (TTC) circuitry 200, and/or the ground and mission control circuitry 112.

In the example of FIG. 2, the antenna pointing control circuitry 124 analyzes the telemetry downlink data 206 received by the TTC ground station antenna 108 and radio frequency power associated with the mission downlink data 210 received by the mission ground station antenna 104 to determine whether a pointing angle of the beam of the MDL antenna 116 should be adjusted. The example antenna pointing control circuitry 124 of FIG. 2 includes telemetry detection circuitry 220, Received Signal Strength Indicator (RSSI) comparator circuitry 222, antenna repointing circuitry 224, and power analysis circuitry 226. In some examples, the antenna pointing control circuitry 124 is implemented at the ground by the ground station control circuitry 212 and/or the ground and mission control circuitry 112. In some examples, the antenna pointing control circuitry 124 is implemented by the vehicle control circuitry 204 of the space vehicle 110. In some examples, one or more of the components of the antenna pointing control circuitry 124 are implemented at the ground by the ground station control circuitry 212 and/or the ground and mission control circuitry 112 and one or more of the components of the antenna pointing control circuitry 124 are implemented by the vehicle control circuitry 204 of the space vehicle 110.

The telemetry detection circuitry 220 of the example antenna pointing control circuitry 124 of FIG. 2 determines the transmission activity status of the MDL antenna 116 based on the telemetry downlink data 206. In examples in which the antenna pointing control circuitry 124 is implemented at the ground (e.g., by the ground station control circuitry 212), the telemetry detection circuitry 220 can access the telemetry downlink data 206 from the TTC ground station database 208 and/or receive the telemetry downlink data 206 from the TTC circuitry 200. In examples in which the antenna pointing control circuitry 124 is implemented by the vehicle control circuitry 204 of the space vehicle 110, the telemetry detection circuitry 220 can access the transmission activity status of the MDL antenna 116 locally at the space vehicle 110 (in this example, the telemetry downlink data 206 including the transmission activity status of the MDL antenna 116 can still be transmitted to the TTC ground station antenna 108 for other analysis purposes).

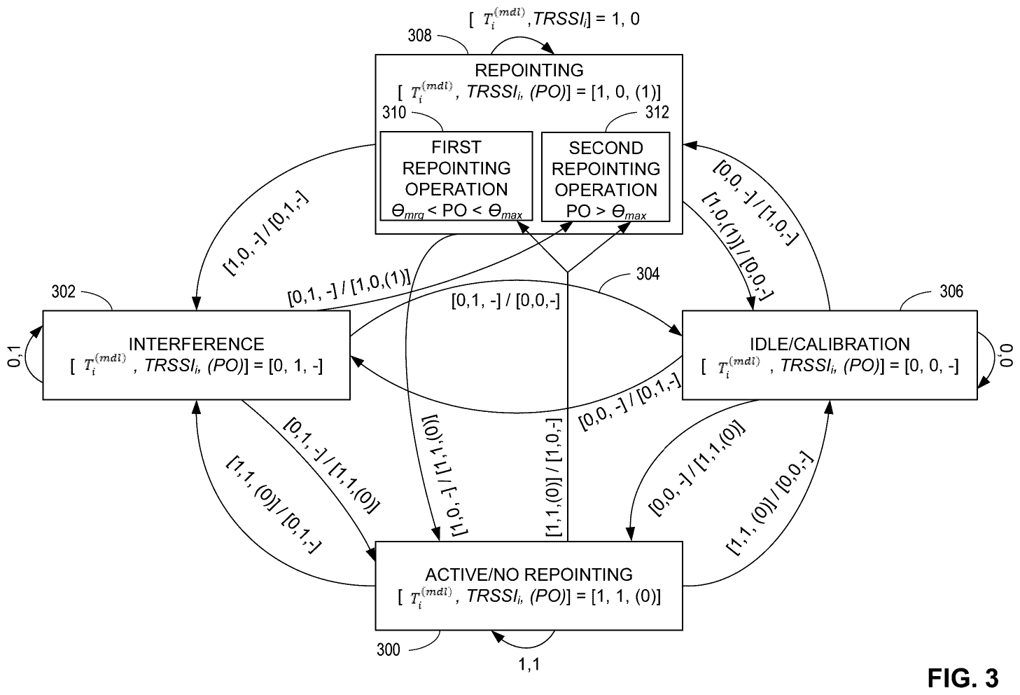

The RSSI comparator circuitry 222 of the example antenna pointing control circuitry 124 of FIG. 2 analyzes the RSSI of the signals (i.e., the signals corresponding to the mission downlink data 210) received and measured by the mission ground station antenna 104 (i.e., a mission downlink receiver) from the MDL antenna 116 (i.e., a mission downlink transmitter, FIG. 5A). The RSSI comparator circuitry compares the RSSI values for the signals to threshold RSSI value(s) 230. The threshold RSSI value(s) 230 can be defined by programmable user inputs. The threshold RSSI value(s) 230 can be defined during a calibration state of the system 100 (e.g., as disclosed in connection with block 306 of FIG. 3).

The threshold RSSI value(s) 230 are stored in a database 232 accessible by the antenna pointing control circuitry 124. In some examples, the database 232 is the same database as the TTC ground station database 208 or the mission ground station database 214 (e.g., when the antenna pointing control circuitry 124 is implemented at the ground). The example database 232 of FIG. 2 is implemented by any memory, storage device and/or storage disc for storing data such as, for example, flash memory, magnetic media, optical media, solid state memory, hard drive(s), etc.

In examples in which the antenna pointing control circuitry 124 is implemented by the ground station control circuitry 212, the RSSI comparator circuitry 222 measures the RSSI at the mission ground station antenna 104. In examples in which the antenna pointing control circuitry 124 is implemented by the vehicle control circuitry 204 of the space vehicle 110, the ground station control circuitry 212 can measure the RSSI of the signals received at the mission ground station antenna 104. The measured RSSI can be included in the command uplink data 202 transmitted to the space vehicle 110 via the TTC ground station antenna 108. The RSSI comparator circuitry 222 implemented at the space vehicle 110 can access the measured RSSI values from the command uplink data 202 received by the first antenna 114.

Also, although examples disclosed herein are primarily discussed in connection with power sensing or RSSI measurements at the mission ground station antenna 104, in some examples, the MDL antenna 116 has a transceiver (e.g., when the MDL antenna 116 is a patch antenna) and can perform full-duplex communications. In such examples, communication between the first antenna 114 and the TTC ground station antenna is still used for transmitting the transceiver activity status telemetry point of the MDL antenna 116 (e.g., because of reliability of the band in which such communications occur). However, in such examples, a receiver of the MDL antenna 116 of the space vehicle 110 can also perform power RSSI measurements onboard the space vehicle 110. For example, RSSI (power indication) measurements are taken before automatic gain control. Accordingly, the following examples can apply with respect to RSSI power sensing: (a) the MDL antenna 116 is a transmitter only, and sensors for power measurement sensing (RSSI) are located at the mission ground station antenna 104; (b) the MDL antenna 116 is a transceiver, so there are sensors for power measurements (RSSI) at the space vehicle 110 and the mission ground station antenna 104 and (i) measurements take place only onboard the space vehicle 110 or (ii) measurements take place in both places, namely, onboard the space vehicle 110 and at the mission ground station antenna 104 (this example can provide for faster determination of corrections to the beam pointing angle of MDL antenna 116). Also, in some examples, the telemetry point can be transmitted via the MDL antenna 116 to the mission ground station antenna 104. In some examples, when the MDL antenna 116 is a transceiver, both the mission data and the telemetry/command data can be transmitted via a one ground antenna (e.g., the mission ground station antenna 104) and one antenna of the space vehicle 110 (e.g., the MDL antenna 116). For example, the mission data and the telemetry/command data can be multiplexed via the same link.

As disclosed in detail in connection with FIG. 3, the antenna repointing circuitry 224 of the example antenna pointing control circuitry 124 of FIG. 2 determines whether a beam pointing angle of the MDL antenna 116 should be adjusted based on (a) the analysis of the telemetry downlink data 206 (or the locally accessed transmission activity status data when the antenna pointing control circuitry 124 is implemented at the space vehicle 110) and (b) the analysis of the RSSI values by the RSSI comparator circuitry 222. In some examples, the antenna repointing circuitry 224 determines that the pointing angle of the MDL antenna 116 should be adjusted so that the pointing offset of the beam pointing angle of the MDL antenna 116 from its boresight 121 satisfies the link margin angle (i.e., PO≤θ_{mrg}). In some examples, the antenna repointing circuitry 224 outputs instructions to cause an antenna pointing mechanism 228 (e.g., a motor controlling a gimbal or electronically steered array) to adjust the pointing angle of the MDL antenna 116 (e.g., a gimbaled antenna). In some examples, the antenna pointing control circuitry 124 outputs instructions to cause the GNC circuitry 205 to adjust the attitude of the space vehicle 110 to adjust the pointing angle of the MDL antenna 116 (e.g., patch antenna). As disclosed in the connection with FIG. 3, the antenna repointing circuitry 224 determines whether the MDL antenna 116 should be adjusted based on antenna pointing rule(s) 231, power analysis rule(s) 234, and a comparison of the RSSI values to the threshold RSSI value(s) 230. In particular, the antenna repointing circuitry 224 estimates the pointing offset of the beam pointing angle of the MDL antenna 116 from the boresight axis 121 with respect to the link margin angle θ_{mrg} and the maximum off-pointed angle θₘₐₓ based on the comparison of the RSSI values to the threshold RSSI value(s) 230. The antenna pointing rule(s) 231 can be defined by user inputs and stored in the database 232.

FIG. 3 is a state transition diagram showing system states identified by the antenna repointing based on the analysis performed by the telemetry detection circuitry 220 and the RSSI comparator circuitry 222 of the example antenna pointing control circuitry 124 of FIG. 2. As disclosed in connection with FIG. 2, the telemetry detection circuitry 220 analyzes the telemetry downlink data 206 received at the TTC ground station antenna 108 to determine an activity status (e.g., transmission status) of the MDL antenna 116 of the space vehicle 110. Although examples disclosed herein refer to the transmission status or telemetry point of the MDL antenna 116, it should be understood that the space vehicle 110 includes a transmitter (FIG. 5A) associated with the MDL antenna 116 and when the activity status of the transmitter (FIG. 5A) is on, then the transmission status of the MDL antenna 116 is also on. Thus, the transmission status can represent a status of the MDL transmitter (FIG. 5A) associated with the MDL antenna 116. The RSSI comparator circuitry 222 analyzes the RSSI of the signals (e.g., corresponding to the mission downlink data 210) transmitted by the MDL antenna 116 and received at the mission ground station antenna 104. Based on the analysis of the telemetry downlink data 206 and the RSSI values, the antenna repointing circuitry 224 determines whether the pointing angle of the MDL antenna 116 should be adjusted so that the pointing offset of the beam pointing angle of the MDL antenna 116 from the boresight axis 121 of the MDL antenna 116 satisfies the link margin angle (i.e., PO≤θ_{mrg}).

In the example of FIG. 3, the analysis performed by telemetry detection circuitry 220, the RSSI comparator circuitry 222, and the antenna repointing circuitry 224 can be represented by a state vector defined as [Tᵢ^{(mdl)}, TRSSIᵢ, (PO)]. In the state vector, the variable Tᵢ^{(mdl)} is a mission downlink state telemetry point as determined by the telemetry detection circuitry 220 based on analysis of the telemetry downlink data 206 (or based on locally accessed data about the transmission status of the MDL antenna 116 (i.e., the transmission status of an MDL transmitter 500 (FIG. 5A) associated with the MDL antenna 116) when the antenna pointing control circuitry 124 is implemented at the space vehicle 110). As noted above, although examples disclosed herein refer to the transmission status of the MDL antenna 116, it should be understood that the space vehicle 110 includes a transmitter (FIG. 5A) associated with the MDL antenna 116 and when the activity status of the transmitter (FIG. 5A) is on, then the transmission status of the MDL antenna 116 is also on. Typically, the mission downlink state telemetry point Tᵢ^{(mdl)} is transmitted in the S-band frequency range. In some examples, the mission downlink state telemetry point Tᵢ^{(mdl)} represents a real-time or substantially real-time indication of whether the MDL antenna 116 (e.g., the associated MDL transmitter 500 of FIG. 5A) is transmitting data (in some instances (e.g., a GEO satellite), it can take approximately 120 ms for a telemetry signal to travel from the first or hemispherical antenna 114 to the TTC ground station antenna 108 however, this can differ if, for example, the telemetry signals are transmitted every 20 ms). For instance, the telemetry detection circuitry 220 can assign the telemetry point Tᵢ^{(mdl)} a value of 1 to represent transmission and a value of 0 to represent no transmission by the MDL antenna 116. In some examples, the telemetry detection circuitry 220 determines the telemetry point value (e.g., 1 or 0) based on the real-time or substantially real-time activity status in the telemetry downlink data 206 (or the locally accessed data about the transmission status of the MDL antenna 116 when the antenna pointing control circuitry 124 is implemented at the space vehicle 110). In other examples, the value assigned to the mission downlink state telemetry point Tᵢ^{(mdl)} (e.g., 0 or 1) indicates that the MDL antenna 116 has transmitted (e.g., within a previously defined time period, such as within the past two minutes) or is expected to transmit data (e.g., within a future defined period of time, such as in the next two minutes).

In the state vector, the variable TRSSIᵢ indicates whether or not the RSSI of the signals received from the second (MDL) antenna 116 by the mission ground station antenna 104 satisfy the threshold RSSI value(s) 230. For instance, the RSSI comparator circuitry 222 can assign the TRSSIᵢ variable in the state vector a value of 1 when the RSSI measured for the signals received by the mission ground station antenna 104 satisfies the threshold RSSI value(s) 230. The RSSI comparator circuitry 222 can assign the TRSSIᵢ variable a value of 0 when the RSSI measured for the signals at the mission ground station antenna 104 does not satisfy the threshold RSSI value(s) 230. In some examples, the threshold RSSI value(s) 230 are defined by a pair of power level threshold values, such as T₁ and T₂. For instance, the threshold RSSI value(s) 230 can define that when the RSSI value(s) measured for the signals received at the mission ground station antenna 104 reach or exceed a first threshold T₁ (i.e., RSSI≥T₁), then the pointing offset satisfies the link margin angle (i.e., θ≤θ_{mrg}). The threshold RSSI value(s) 230 can define that when the RSSI value(s) are measured for the signals received at the mission ground station antenna 104 are less than a second threshold T₂ (RSSI<T₂), then the pointing offset exceeds the maximum off-pointed angle (i.e., θ>θₘₐₓ). The RSSI threshold values T₁ and T₂ can be in the X-band frequency range. In some examples herein, the link margin angle threshold T₁ is also referred to herein as T^{(X)}. However, the RSSI threshold values T₁ and T₂ can be defined in other frequency bands such as K, Ka, Ku, V, Q, etc. In some examples, the higher the frequency, the stronger effects of weather on the received signal, and, thus, in some examples, scaling is applied to the RSSI threshold values T₁ and T₂. The threshold RSSI value(s) 230 can correspond to a power level that, when exceeded, satisfies the link margin (e.g., signal strength level) for reception of signal(s) transmitted by the space vehicle at the ground antenna). Thus, the power threshold for determining whether the beam pointing angle should be adjusted may be different than a value associated with peak power. However, in some examples, the peak power level may serve as the threshold for determining whether the beam pointing angle should be adjusted.

The example telemetry detection circuitry 220 and the RSSI comparator circuitry 222 can perform the respective analyses periodically, such as every several hundred milliseconds. As a result of the periodic analysis by the example telemetry detection circuitry 220 and the RSSI comparator circuitry 222, N data pairs of [Tᵢ^{(mdl)}, TRSSIᵢ], where i=1 . . . N, are formed. The state vector pairs can be stored in the database 232. Thus, in the state vector, the transmission status of the MDL antenna 116 as represented by the mission downlink state telemetry point T_{mdl}^{(s)}(i) is paired with the TRSSI value (TRSSIᵢ) assigned based on the RSSI measured for the signals received at the mission ground station antenna 104.

In the state vector, the variable PO indicates whether the pointing offset of the beam pointing angle of the MDL antenna 116 relative to the boresight 121 warrants repointing of the beam of the gimbaled antenna 116 to satisfy the link margin angle (i.e., PO≤θ_{mrg}). As disclosed herein, the variable PO can be identified if the variable TRSSIᵢ is known. The antenna repointing circuitry 224 assigns the variable PO a value of 1 when the antenna repointing circuitry 224 determines that the pointing angle of the gimbaled antenna 116 should be adjusted (i.e., when PO>θ_{mrg}). The antenna repointing circuitry 224 assigns a value of “0” to the variable PO when the antenna repointing circuitry 224 determines that the pointing angle of the MDL antenna 116 does not need to be adjusted (e.g., because the pointing offset satisfies the link margin angle (i.e., PO≤θ_{mrg}).

Referring to the state diagram of FIG. 3, in some examples, the telemetry detection circuitry 220 determines that the transmission status of the MDL antenna 116 indicates transmission of the mission downlink data 210. Also, the RSSI comparator circuitry 222 determines that the RSSI of the signals corresponding to the mission downlink data 210 is greater than the threshold RSSI value(s) 230. Thus, referring to the state vector, (a) the telemetry detection circuitry 220 determines that Tᵢ^{(mdl)}=1 and (b) the RSSI comparator circuitry 222 determines that TRSSIᵢ=RSSIᵢ≥T₁=1 (e.g., RSSIᵢ≥T₁), where RSSIi (sometimes referred to as P^{(X)}) represents power present in the signals received from the MDL antenna 116, T₁ represents the threshold RSSI value(s) 230 for the signals (e.g., power threshold T₁), and X refers to the X-band frequency range (however, the frequency band could be different, such as K, Ka, Ku, V, Q, C-band). For example, T₁ can represent a power threshold that is exceeded when identifying peak power reception by the mission ground station antenna 104. In this example, the antenna repointing circuitry 224 determines that both conditions are satisfied with respect to transmission by the MDL antenna 116 and the RSSI of the signals received by the mission ground station antenna 104 satisfying the threshold RSSI value(s) 230 (e.g., RSSIi≥T₁ without achieving peak power reception). Based on the antenna pointing rule(s) 231, the antenna repointing circuitry 224 determines that no repointing of the MDL antenna 116 is presently needed (i.e., PO≤θ_{mrg} and, thus, no repointing is needed), as represented by block 300 in FIG. 3.

In some examples, the telemetry detection circuitry 220 determines (e.g., based on the telemetry downlink data 206) that the MDL antenna 116 is not transmitting (or has not transmitted, or will not transmit) data. As such, Tᵢ^{(mdl)}=0 in the state vector. However, the RSSI comparator circuitry 222 determines that the RSSI of the signal detected by the mission ground station antenna 104 satisfies the RSSI threshold (i.e., in the state vector, TRSSIᵢ=RSSIi≥T₁ and thus, TRSSIᵢ=1 in the state vector). In such examples, based on the antenna pointing rule(s) 231, the antenna repointing circuitry 224 determines that the signals detected by the mission ground station antenna 104 are interference. For instance, the signals may have been transmitted by a space vehicle other than the space vehicle 110 or other terrestrial radiation sources. As such, based on the antenna pointing rule(s) 231, the antenna repointing circuitry 224 determines that no action is required with respect to positioning the MDL antenna 116, as represented by block 302 in FIG. 3 (but other actions may be performed with respect to the MDL antenna 116 (e.g., transmitter, receiver) set to idle, as shown via the transition (arrow 304) from block 302 to block 306 in FIG. 3).

In some examples, the interference detected at block 302 of FIG. 3 represents hacking. For example, the telemetry detection circuitry 220 can determine (e.g., based on the telemetry downlink data 206) that the MDL antenna 116 is not transmitting (or has not transmitted, or will not transmit) data. However, the signal authentication circuitry 216 may have approved a message received via the mission ground station antenna 104. Because the telemetry detection circuitry 220 determined that the MDL antenna 116 of the space vehicle 110 is not transmitting data, the message approved by the post-authentication circuitry 219 can be considered unintentional or, in some instances, intentional hacking. In some instances, when the signal authentication circuitry 216 rejects a message as not valid, the message can be unintentional interference (e.g., spectral leakage from another satellite) or, in some instances, intentional jamming.

In examples in which the antenna repointing circuitry 224 determines that there is interference (e.g., jamming) or hacking, the antenna repointing circuitry 224 can cause the system 100 of FIG. 1 to enter an idle and/or calibration state, as represented by arrow 304 and block 306 in FIG. 3. As a result, the TTC ground station antenna 108 stops transmitting data so as not to inadvertently output data (e.g., sensitive data) that can be detected by another space vehicle. Also, the antenna repointing circuitry 224 can generate instructions to cause the MDL antenna 116 (transmitter, FIG. 5A) to enter an idle state and the mission ground station antenna 104 to stop receiving data (e.g., instruct the mission ground station antenna 104 not to store any detected data or transfer to and detected data to the ground station control circuitry 212, cause a receiver of the mission ground station antenna 104 be set to idle). Thus, in the idle state of the system 100, the mission downlink state telemetry point is defined as Tᵢ^{(mdl)}=0 and the TRSSIᵢ variable is defined as TRSSIᵢ=0, the pointing offset (PO) variable is null. In some examples, when the system 100 is in the idle state, the antenna repointing circuitry 224 can cause a calibration process to be performed in which the beam pointing angle of the MDL antenna 116 is adjusted so that the beam pointing angle of the MDL antenna 116 and the boresight axis 121 of the MDL antenna 116 are aligned or substantially aligned when communication between the space vehicle 110 and the mission ground station antenna 104 resumes. In some examples, rather than performing calibration (e.g., if there are delays in performing calibration), the antenna repointing circuitry 224 identifies the last orientation of the MDL antenna 116 before interference was detected and causes the MDL antenna 116 to return to that orientation when operation resumes (e.g., taking into account the relative drift (e.g., geosynchronous (GEO) orbit) or travel (e.g., low earth orbit (LEO)) during the idle mode).

In some examples, if the telemetry detection circuitry 220 determines that the MDL antenna 116 transmitted data (Tᵢ^{(mdl)}=1) and the RSSI comparator circuitry 222 determines that TRSSIᵢ=1 (e.g., RSSIi≥T₁) but the message was not authenticated by the signal authentication circuitry 216 (e.g., the post-authentication circuitry 219 failed to authenticate the message), the antenna repointing circuitry 224 can instruct (e.g., via the TTC ground station antenna 108), the vehicle control circuitry 204 to re-transmit the message. The request for re-transmission can be repeated a finite number of time (e.g., an upper bound is preset). In this example, either there is a number of bits in error in the message (due to higher levels of thermal noise at the ground receiver, for example), or the telemetry bit was received in error (i.e., Tᵢ^{(mdl)}=1 instead of Tᵢ^{(mdl)}=0 as expected, thereby “fooling” the pre-authentication circuitry 217 such that re-transmission is not effective). In examples in which the telemetry bit was received in error (i.e., Tᵢ^{(mdl)}=1 instead of Tᵢ^{(mdl)}=0), the pre-authentication circuitry 217 of the signal authentication circuitry 216 of FIG. 2 does not detect receiver interference; rather, although failure of message pre-authentication was expected, the pre-authentication circuitry 217 falsely passes the message (e.g., due to S-band interference). In such examples, the post-authentication processing performed by the post-authentication circuitry 219 can either successfully reject the message (e.g., interpret errors due to noise) or also fail. If the interference is a transient type of interference, then after a number of repeated re-transmissions, the authentication issue should be resolved. The upper bound for re-transmission of the message can be selected so that at least the last re-transmission of the message will happen past the effects of the transient interference. If the re-transmission is not successful, the antenna repointing circuitry 224 can generate instructions for the space vehicle 110 to stop transmitting data until the issue is identified and resolved.

In some examples, the telemetry detection circuitry 220 determines (e.g., based on telemetry downlink data 206) that the MDL antenna 116 is transmitting (or has transmitted, or will transmit) data. Thus, Tᵢ^{(mdl)}=1 in the state vector. However, the RSSI comparator circuitry 222 determines that the power level (RSSI) of the signals detected by the mission ground station antenna 104 is less than the RSSI threshold (i.e., RSSIᵢ<T₁ and, thus, TRSSIᵢ=0 in the state vector). In such examples, PO>θ_{mrg}=1 in the state vector, as represented by block 308 in FIG. 3. Thus, the antenna repointing circuitry 224 determines that the beam pointing angle of the second or MDL antenna 116 should be adjusted to satisfy the pointing offset thresholds.

As disclosed herein, pairs of the mission downlink state telemetry point and TRSSI variable are formed (i.e., [Tᵢ^{(mdl)}, TRSSIᵢ]) based on the analysis performed by the telemetry detection circuitry 220 and the RSSI comparator circuitry 222. In some examples, the antenna repointing circuitry 224 determines whether the pointing angle of the MDL antenna 116 should be adjusted based on the most recently generated data pair [Tᵢ^{(mdl)}, TRSSIᵢ]. For example, referring to block 300, in some examples, the antenna repointing circuitry 224 determines, based on the values of the most recently generated data pair [Tᵢ^{(mdl)}, TRSSIᵢ]), that Tᵢ^{(mdl)}=1 and TRSSIᵢ=1. Thus, the antenna repointing circuitry 224 determines that no adjustment to the pointing angle of the MDL antenna 116 is warranted.

In other examples, the antenna repointing circuitry 224 determines whether the pointing angle of the MDL antenna 116 should be adjusted based on historical analysis of the data pairs [Tᵢ^{(mdl)}, TRSSIᵢ]. For example, the antenna pointing rule(s) 231 can define a threshold amount of consensus or non-consensus between the values of Tᵢ^{(mdl)} and TRSSIᵢ. For example, the antenna pointing rule(s) 231 can indicate that when 96% of a certain number of the data pairs [Tᵢ^{(mdl)}, TRSSIᵢ] are [1, 1] to prevent responses to any transients, then the antenna repointing circuitry 224 should determine that no repointing is needed (i.e., block 300 of FIG. 3). Likewise, the antenna pointing rule(s) 231 can indicate that when a certain percentage (e.g., 96%) of the data pairs [Tᵢ^{(mdl)}, TRSSIᵢ] are [1,0], then repointing is warranted (block 308 of FIG. 3). The antenna pointing rule(s) 231 can define that when a certain percentage (e.g., 96%) of the data pairs [Tᵢ^{(mdl)}, TRSSIᵢ] are [0, 1], then a finding of interference is warranted (block 302 of FIG. 3). The antenna pointing rule(s) 231 can define that when a certain percentage (e.g., 96%) of a total set of N data pairs [Tᵢ^{(mdl)}, TRSSIᵢ] are [0, 0] (where the parameter N can be user defined and based on factors such as latency in identifying interference), then a finding that the system 100 of FIG. 1 is an idle and/or calibration state (e.g., no reception) is warranted (block 306 of FIG. 3).

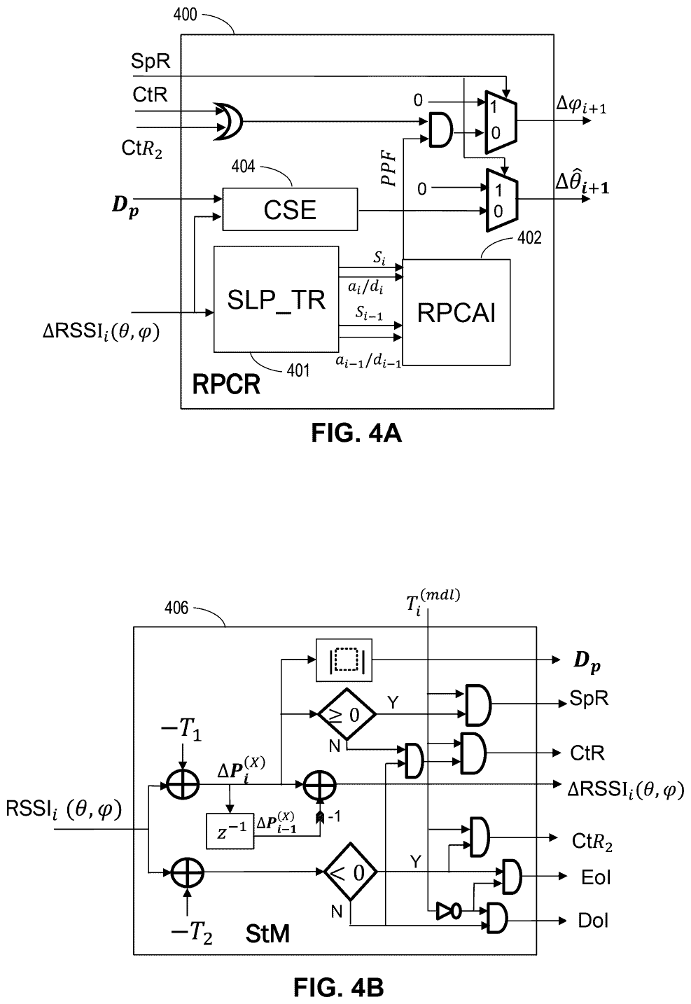

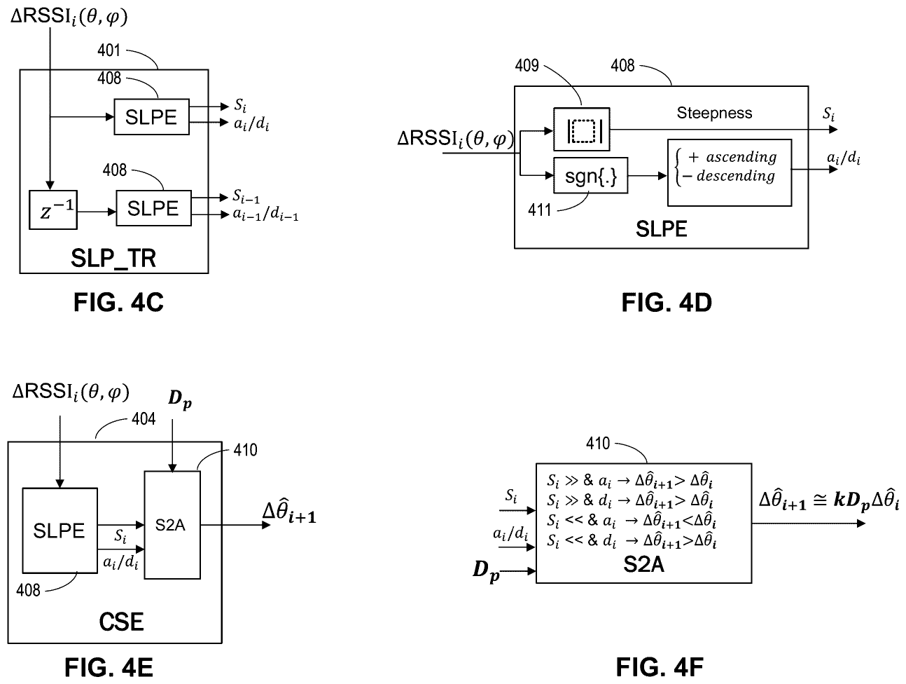

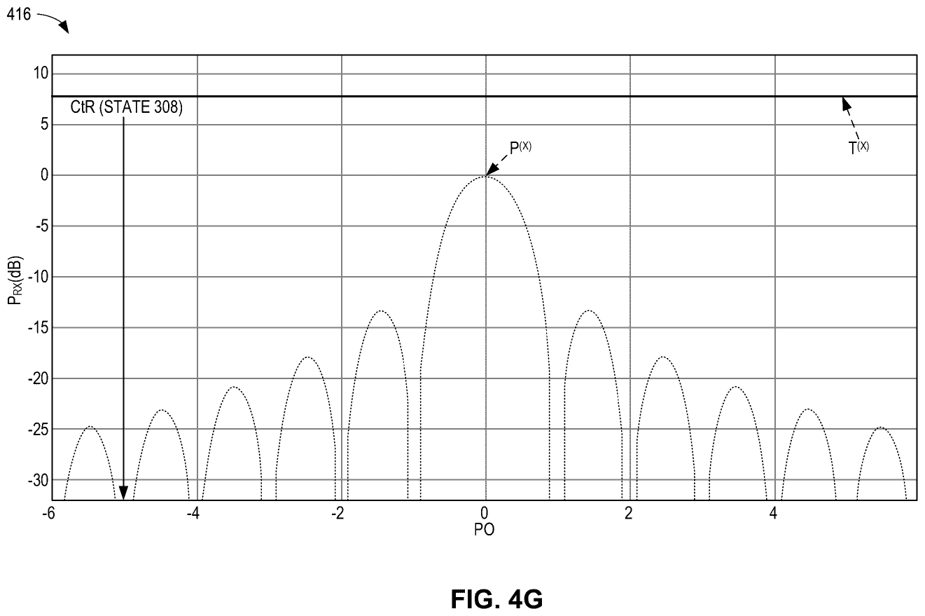

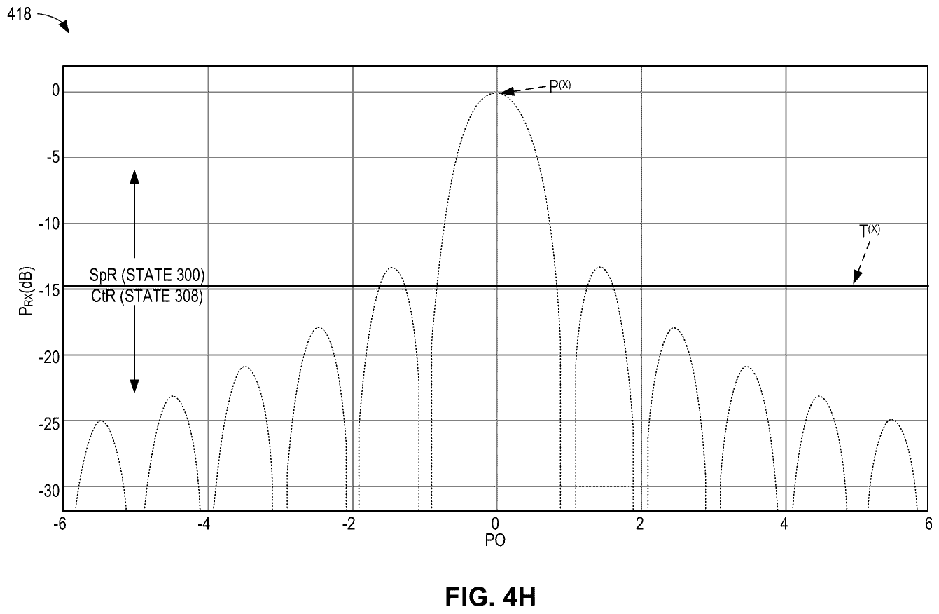

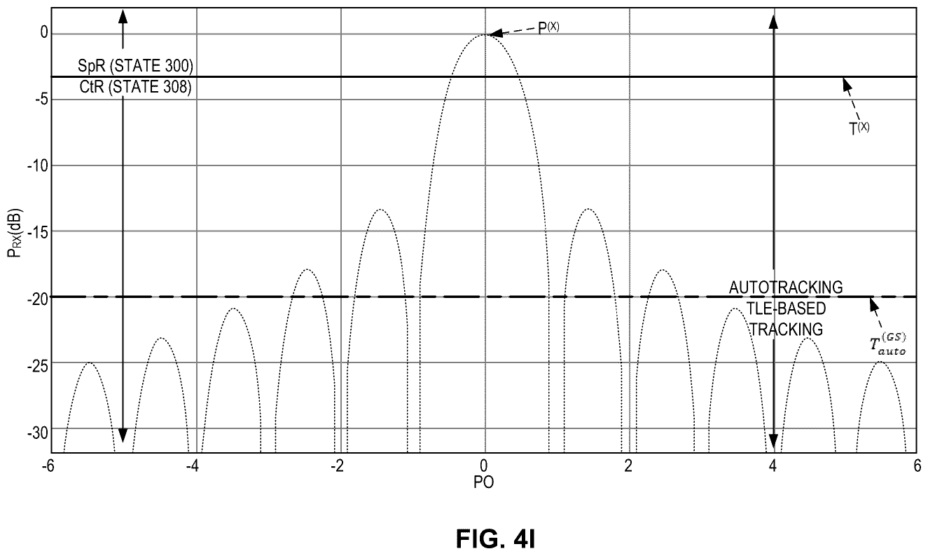

Referring to block 308 of FIG. 3, the antenna repointing circuitry 224 of FIG. 2 estimates the pointing offset between the beam pointing angle of the MDL antenna 116 from the boresight axis 121 with respect to the link margin angle θ_{mrg} and the maximum off-pointed angle θₘₐₓ based on the comparison of the RSSIᵢ value(s) to the threshold RSSI value(s) 230 (i.e., T₁ and T₂). For example, if the antenna repointing circuitry determines that a RSSIᵢ value is less than T₁(RSSIᵢ<T₁) and greater than T₂(RSSIᵢ>T₂), then the antenna repointing circuitry 224 determines, based on the antenna pointing rule(s) 231, that the pointing offset is not large enough to instruct the gimbaled antenna 116 to stop transmission of the mission downlink data 210 (i.e., because PO<θₘₐₓ), but is sufficiently large (i.e., PO>θ_{mrg}) to initiate a first repointing operation as represented by block 310 in FIG. 3. As disclosed herein (FIGS. 4A-4F), in the first repointing operation, the antenna repointing circuitry 224 uses a radiation pattern-cut riding (RPCR) algorithm to achieve or substantially achieve peak power reception (e.g., RSSIᵢ≥T₁) at the mission ground station antenna 104, which results from alignment or substantial alignment between the beam pointing angle of the MDL antenna 116 and the boresight axis 121 of the MDL antenna 116 (i.e., the pointing offset angle θ_{mrg} is satisfied).

If the antenna repointing circuitry 224 determines that an RSSIᵢ value is less than T₂(RSSIᵢ<T₂), then the antenna repointing circuitry 224 determines that PO>θₘₐₓ. In response, the antenna repointing circuitry 224 initiates a second repointing operation as represented by block 312 in FIG. 3. In the second repointing operation, the antenna repointing circuitry 224 instructs the MDL antenna 116 to stop transmission of the mission downlink data 210 to prevent violation of space governance rules (e.g., spectrum management policies). Also, in the second repointing operation, the antenna repointing circuitry 224 causes the pointing angle of the MDL antenna 116 to be adjusted based on, for example, star tracker vehicle data and calibration data (e.g., computed dish boresight pointing and offset relative to the mission ground station 104) so that the pointing offset is less than θₘₐₓ (i.e., PO<θₘₐₓ). When the pointing offset is less than θₘₐₓ, the antenna repointing circuitry 224 instructs the MDL antenna 116 to resume transmitting the mission downlink data 210. Also, when the pointing offset is less than θₘₐₓ, the antenna repointing circuitry 224 can perform the first repointing operation 310 to further adjust the pointing angle of the MDL antenna 116 so that the pointing offset satisfies the link margin angle (i.e., PO≤θ_{mrg}).

Returning again to FIG. 2, in some examples the antenna repointing circuitry 224 determines that T₂<RSSIᵢ<T₁ and, thus, the pointing offset is greater than the link margin angle (PO>θ_{mrg}) but the pointing offset is less than the maximum off-pointed angle (PO<θₘₐₓ). In such examples, the antenna repointing circuitry 224 determines that the MDL antenna 116 should be repointed. In such examples, the antenna repointing circuitry 224 performs the first repointing operation (i.e., block 310 in FIG. 3). In particular, the antenna repointing circuitry 224 outputs instructions to cause the beam pointing angle of the MDL antenna 116 to be adjusted via the antenna pointing mechanism 228 (e.g., via movement of the gimbal) or via adjustments to the attitude of the space vehicle 110 via the GNC circuitry 205. The repointing instructions generated by the antenna repointing circuitry 224 include a particular amount (e.g., a pointing angle adjustment step Δ\hat{θ} (e.g., a degree) by which the beam pointing angle of the MDL (e.g., gimbaled) antenna 116 should be adjusted in an effort to bring the pointing offset at or below the link margin angle (PO≤θ_{mrg}). In some examples, as disclosed in connection with FIGS. 4A-4F, the antenna repointing circuitry 224 determines the pointing angle adjustment step Δ\hat{θ} based on an analysis of the RSSI value(s) measured for the signal(s) received at the mission ground station antenna 104.

In examples in which the antenna pointing control circuitry 124 is implemented at the ground (e.g., by the ground station control circuitry 212), the antenna adjustment instructions can be transmitted to the space vehicle 110 via the TTC ground station antenna 108 (e.g., the pointing angle adjustment step Δ\hat{θ} is included in the command uplink data 202). The vehicle control circuitry 204 can analyze the received instructions and provide further instructions at the space vehicle 110 to cause the antenna pointing mechanism 228 to move (e.g., instruct a motor of the antenna pointing mechanism to move based on a pointing angle adjustment step included in the command uplink data 202) or cause the GNC circuitry 205 to change the space vehicle's attitude. In examples in which the antenna pointing control circuitry 124 is implemented at the space vehicle 110, the antenna repointing circuitry 224 can transmit the instructions to, for instance, a motor associated with the antenna pointing mechanism 228 (e.g., gimbal) to cause the antenna pointing mechanism 228 to move by a certain amount. In examples in which the beam pointing angle of the MDL (e.g., patch) antenna 116 is to be adjusted via control of the space vehicle's attitude, the GNC circuitry 205 can analyze the received instructions (i.e., received in the command uplink data or via the antenna pointing control circuitry 124 implemented at the space vehicle 110) to determine adjustments to the attitude of the space vehicle 110 based on the pointing angle adjustment step Δ\hat{θ}.

The example antenna pointing control circuitry 124 of FIG. 2 includes power analysis circuitry 226. In the process of seeking the power peak, the power analysis circuitry 226 determines when the received power exceeds the threshold T₁. The power analysis circuitry 226 analyzes the signals transmitted by the MDL antenna 116 and received by the mission ground station antenna 104 during the first repointing operation. In particular, the power analysis circuitry 226 analyzes radiation patterns for the mission ground station antenna 104 associated with the signals transmitted by the gimbaled antenna 116 and received by the mission ground station antenna 104. Based on the received antenna radiation patterns generated during the first repointing operation, the power analysis circuitry 226 searches for peak power and detects when, for example, the received power exceeds the RSSI threshold T₁ and thus, satisfies the link margin angle θ_{mrg}.

The radiation patterns for the mission ground station antenna 104 (e.g., a reflector antenna) representing signals received from the MDL antenna 116 can include a main lobe and side lobes as a function of pointing angle θ, where the main lobe is associated with highest power at the boresight 121 (i.e., θ=0). The power analysis circuitry 226 analyzes the received power represented by the lobes of the radiation pattern relative to the RSSI threshold T₁ associated with the link margin angle θ_{mrg}. In particular, the power analysis circuitry 226 executes a peak power searching algorithm based on the lobes of the radiation pattern to determine whether the received signal strength RSSIᵢ≥T₁ has been achieved. For example, the power analysis circuitry 226 analyzes the lobes to detect local maximum power levels and to identify if global peak power has been achieved based on changes in the local maximum power levels that define the lobes. During the analysis of the radiation pattern(s), the power analysis circuitry 226 can detect when one of the lobes of the radiation pattern crosses the RSSI threshold T₁, thereby indicating that the link margin angle θ_{mrg} is satisfied when the MDL antenna 116 is at the corresponding beam pointing angle θ.

During the first repointing operation, the MDL antenna 116 is moved (e.g., via the antenna pointing mechanism 228) such that the antenna beam is at a particular pointing angle θ and emits signals, which are detected by the mission ground station antenna 104. The power analysis circuitry 226 analyzes a radiation pattern for the mission ground station antenna 104 associated with the receipt of signals from the MDL antenna 116 when the MDL antenna 116 is at that pointing angle θ. The power analysis circuitry 226 determines, based on power analysis rule(s) 234, whether a RSSI threshold T₁ has been satisfied or, in some examples, a peak of signal power of the signals received at the mission ground station antenna 104 has been achieved when the MDL antenna 116 is at a particular pointing angle θ. The power analysis rule(s) 234 can be defined by user inputs and stored in the database 232.

The antenna repointing circuitry 224 of FIG. 2 executes the first repointing operation to change, correct, or otherwise adjust the beam pointing angle θ of the MDL antenna 116 to maximize received power RSSIᵢ (i.e., X-band; however, other bands such as K, Ka, Ku, V, Q may be used instead) of the signals received by the mission ground station antenna 104. As further disclosed in connection with FIGS. 4A-4F, in some examples, the antenna repointing circuitry 224 instructs, based on the antenna pointing rule(s) 231 and the power analysis performed by the power analysis circuitry 226, the MDL antenna 116 to move in series of iterative steps. In particular, the antenna repointing circuitry 224 instructs the antenna pointing mechanism 228 to move the gimballed antenna 116 or instructs the GNC circuitry 205 to move the space vehicle's attitude such that a size of the pointing angle adjustment step Δ\hat{θ} could be proportional to a distance ΔPᵢ^{(X)} of the received power RSSIᵢ from the RSSI threshold T₁ (e.g., |ΔPᵢ^{(X)}|=|RSSIᵢ−T₁|). In some examples, the antenna repointing circuitry 224 instructs the gimbaled antenna 116 to move a first amount (e.g., a larger amount) and then instructs the gimbaled antenna 116 to move in a series of steps (e.g., gradually smaller amounts) to refine the beam pointing angle of the gimbaled antenna 116 through an iterative process. In examples in which the MDL antenna 116 is a patch antenna, the GNC circuitry 205 (based on instructions from the antenna repointing circuitry 224) causes the attitude of the space vehicle 110 to change by a first amount (e.g., a larger amount) and then instructs the space vehicle attitude to change in a series of steps (e.g., gradually smaller amounts) to refine the beam pointing angle of the patch antenna 116 through an iterative process.

As a result of the iterative refinements, the distance ΔPᵢ^{(X)}, relative to the RSSI threshold T₁ changes. The power analysis circuitry 226 can use the changes in the ΔP^{(X)} to analyze the lobes of the radiation pattern. For examples, the power analysis circuitry 226 can identify when, for example, one of the lobes is crossed by the RSSI threshold T₁ as a result of the changes to the beam pointing angle θ, thereby indicating that the link margin angle θ_{mrg} is satisfied. For example, the distance ΔPᵢ^{(X)} relative to the RSSI threshold T₁ decreases in average in examples in which a lobe of a radiation pattern is crossed by the RSSI threshold T₁. In such examples, the power analysis circuitry 226 can identify that the lobe is a lobe of interest with respect to detecting that the link margin angle θ_{mrg} has been satisfied by the adjustments to the beam pointing angle. In instances in which a lobe of the radiation pattern is not crossed by threshold T₁, then the power distance ΔP(X) will iteratively decrease and increase without crossing T₁. In such examples, the power analysis circuitry 226 continues to analyze the lobes of the radiation pattern until the lobe of interest (i.e., the lobe that crosses threshold T₁) is identified such that the power distance ΔPᵢ^{(X)} only decreases.

In some examples, the antenna repointing circuitry 224 estimates an initial size of the adjustment step Δ\hat{θ}, to be applied to the beam pointing angle of the MDL antenna 116 based on an offset ΔP₀^{(X)} of the initially received power P₀^{(X)} from the RSSI threshold T^{(X)}. As the antenna repointing circuitry 224 continues to execute the first repointing operation, at iteration i, the step size Δ\hat{θ}ᵢ is reduced, as the power offset ΔPᵢ^{(X)} is also reduced by applying successive adjustments during preceding iterations. For example, the iterative process can be represented by the following expression:

$$Δ {P}_{i}^{( X )} < Δ {P}_{i - 1}^{( X )} ⇒ Δ {\hat{θ}}_{i} \leq Δ {\hat{θ}}_{i - 1} , i = 1 , 2 , ⋯$$

In some examples, the power analysis circuitry 226 compares the RSSI values measured when the beam pointing angle of the MDL antenna 116 is at a first pointing angle and a second pointing angle. Based on a difference between the RSSIᵢ values, the power analysis circuitry 226 determines whether the RSSIᵢ values indicate that a particular pointing angle of the MDL antenna 116 is approaching or has resulted in crossing the RSSI threshold T₁ or reaching peak power at the mission ground station antenna 104 (e.g., determine in which direction to optimize the pointing angle). As disclosed herein (FIGS. 4A-4F), the power analysis circuitry 226 correlates the changes in RSSI values with properties (e.g., slopes) of the received antenna radiation pattern to determine intermediate progress (e.g., ascending towards peak power) and whether the differential RSSI indicates that peak power has been achieved.

For example, after the power analysis circuitry 226 detects a potential power maximum based on RSSI values received by the mission ground station antenna 104 at respective beam pointing angles of the MDL antenna 116 and the RSSI threshold T₁ has not been reached yet as determined based on the RSSI values of the received signals, the antenna pointing mechanism 228 continues to adjust the pointing angle of the MDL antenna 116. In some examples, the power analysis circuitry 226 detects the power maximum based on an a-priori estimate of an order of magnitude of the expected power; in other examples the power maximum is estimated by the power analysis circuitry 226 during the pointing angle adjustment operations. The power analysis circuitry 226 continues to analyze the power levels of the received signals to determine if the subsequent local maximum power levels decrease or continue to increase. If the local maximum power level(s) decrease after the last detected maximum, then the power analysis circuitry 226 recognizes the detected maximum as the global peak power and determines that the MDL antenna 116 should return to the corresponding last pointing angle at which the peak power was detected. In such examples, the power analysis circuitry 226 outputs instructions to cause the MDL antenna 116 to return to the pointing angle associated with the global peak power. If the power level(s) increase after the initial detected maximum power, then the power analysis circuitry 226 determines that the MDL antenna 116 should continue to be adjusted, as the peak power has not yet been achieved. In some examples, the power analysis circuitry 226 communicates with the antenna repointing circuitry 224 to output instructions for the beam pointing angle of the MDL antenna 116 to continue to move (e.g., via the antenna pointing mechanism 228 or via changes to the space vehicle attitude). However, in the aforementioned examples, if, during execution of the peak power searching algorithm (i.e., the analysis of the local maximum power levels to identify the global peak power), the power analysis circuitry 226 determines that the RSSI threshold T₁ has been reached (e.g., one of the lobes of the radiation pattern is crossed by the RSSI threshold T₁ such that RSSIi≥T₁), then the power analysis circuitry 226 communicates with the antenna repointing circuitry 224 to stop the iterative changes to the beam pointing angle of the MDL antenna 116. Rather, because the RSSI threshold T₁ has been met at a particular beam pointing angle, the power analysis circuitry 226 determines that the link margin angle θ_{mrg} has been satisfied.

In some examples, the power analysis circuitry 226 uses slope criteria associated with the radiation pattern received by the mission ground station antenna 104 to identify the crossing of the RSSI threshold T₁ or the peak power in response to a stepped or iterative adjustment of the antenna pointing mechanism 228. For example, the slope information can be used by the power analysis circuitry 226 to determine where on the radiation pattern the received signal strength is located relative to peak power in response to each iteration of repointing the beam pointing angle based on execution of the peak power searching algorithm. As disclosed herein (FIGS. 4A-4F), the power analysis circuitry 226 analyzes differences in RSSI values measured when the beam pointing angle of the MDL antenna 116 is at a first pointing angle and a second pointing angle. The differential RSSI value can be indicative of properties of lobes in the radiation pattern (e.g., a main lobe, side lobes). For example, the differential RSSI value can be translated to changes in the slope of the lobe(s) of the radiation pattern. The changes in slopes can be indicative of a peak or a null (indicating minimum field signal strength) or a noise floor in the radiation pattern. Table 1, below, provides example criteria (e.g., defined by the power analysis rule(s) 234) for analyzing the slopes associated with lobes in the radiation pattern.

TABLE 1

| | Radiation Pattern-Cut Area |
|---|---|
| Slope | Identifier (RPCAI) |
| +ve -> +ve, or −ve -> −ve | Riding a lobe upwards or |
| | downwards |
| +ve slope -> 0 slope -> −ve slope | Traversed a peak, peak power |
| | found (PPF) |
| −ve slope -> 0 slope -> +ve slope | Traversed a null |
| −ve slope -> 0 slope, or fluctuating | Descending from a sidelobe to the |
| near 0 slope | noise floor |
| Slop fluctuating near 0 slope (e.g., | “noise floor” area |
| relatively flat) | |
| Slope going from “+ve steeper” to | Approaching a peak |
| “+ve flatter” | |
| Slope going from “−ve flatter to “−ve | Distancing from a peak |
| steeper” | |

Thus, in the first repointing operation to control the beam pointing angle of the MDL antenna 116, the antenna repointing circuitry 224 generates instructions to cause the antenna pointing mechanism 228 to move (or cause space vehicle attitude to change) to maximize power (e.g., RSSI) of the signals received by the mission ground station antenna 104. As disclosed herein, in some examples, the power analysis circuitry 226 compares the RSSI values generated during the first repointing operation to the threshold RSSI value(s) 230 (e.g., T₁) to verify that the position of the antenna pointing mechanism 228 (or space vehicle attitude) associated with that received power also satisfies the threshold RSSI value(s) 230 (i.e., RSSI≥T₁), thereby indicating that the pointing offset of the beam pointing angle of the MDL antenna 116 relative to the boresight axis 121 satisfies the link margin angle θ_{mrg}, and, thus, PO≤θ_{mrg}.

In some examples, the antenna repointing circuitry 224 generates instructions to cause the beam pointing angle of the MDL antenna 116 to be adjusted to further increase alignment between the beam pointing angle of the MDL antenna 116 and its line-of-sight with the mission ground station antenna 104 and, thus, alignment between the MDL antenna 116 and the location of the mission ground station antenna 104 based on execution of the first repointing operation at block 310 of FIG. 3 (e.g., θ_{mrg}<PO<θₘₐₓ). The power analysis circuitry 226 can analyze the signals from the MDL antenna 116 to search for peak power and detect (e.g., verify, sense) exceedance of the RSSI threshold T₁ to position the MDL antenna 116 as disclosed above in connection with the first repointing operation (block 310 of FIG. 3).

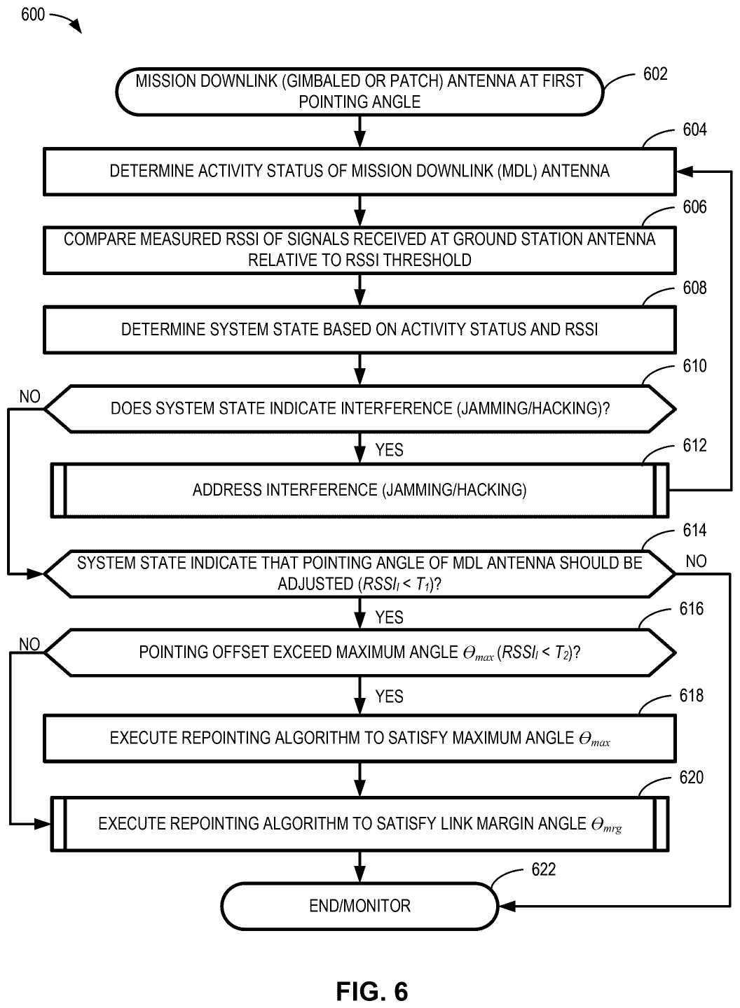

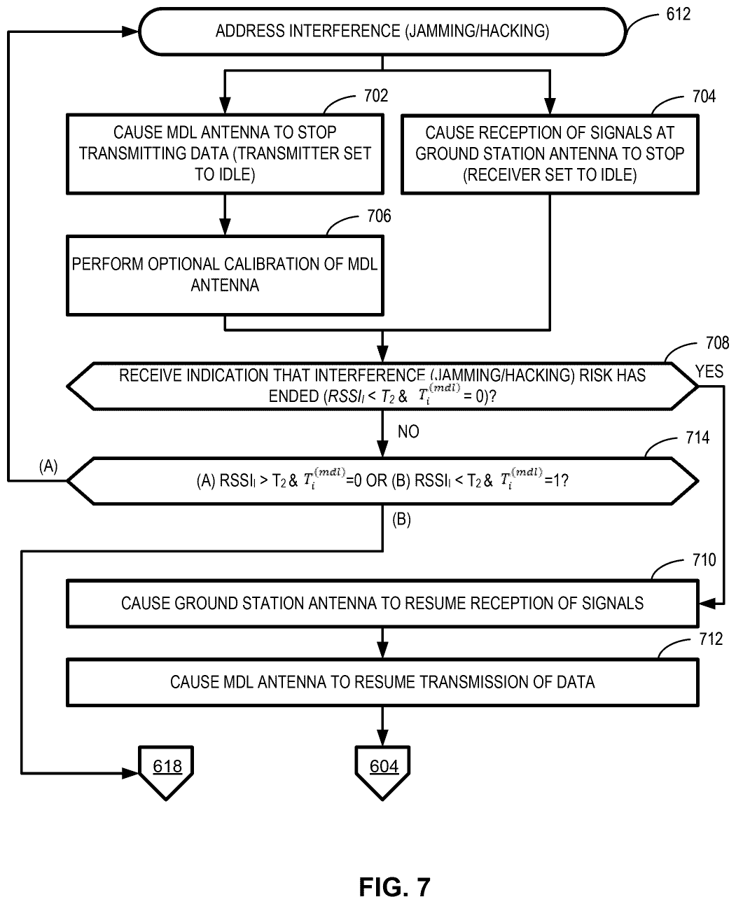

In some examples, the telemetry detection circuitry 220 is instantiated by programmable circuitry executing telemetry detection instructions and/or configured to perform operations such as those represented by the flowchart(s) of FIGS. 6 and/or 7. In some examples, the RSSI comparator circuitry 222 is instantiated by programmable circuitry executing RSSI comparator instructions and/or configured to perform operations such as those represented by the flowchart(s) of FIGS. 6 and/or 7. In some examples, the antenna repointing circuitry 224 is instantiated by programmable circuitry executing antenna repointing instructions and/or configured to perform operations such as those represented by the flowchart(s) of FIGS. 6, 7, and/or 8. In some examples, the power analysis circuitry 226 is instantiated by programmable circuitry executing antenna repointing instructions and/or configured to perform operations such as those represented by the flowchart(s) of FIGS. 6 and/or 8.

While an example manner of implementing the antenna pointing control circuitry 124 of FIG. 1 is illustrated in FIG. 2, one or more of the elements, processes, and/or devices illustrated in FIG. 2 may be combined, divided, re-arranged, omitted, eliminated, and/or implemented in any other way. Further, the example telemetry detection circuitry 220, the example RSSI comparator circuitry 222, the example antenna repointing circuitry 224, the example power analysis circuitry 226, and/or, more generally, the example antenna pointing control circuitry 124 of FIG. 2, may be implemented by hardware alone or by hardware in combination with software and/or firmware. Thus, for example, any of the example telemetry detection circuitry 220, the example RSSI comparator circuitry 222, the example antenna repointing circuitry 224, the example power analysis circuitry 226, and/or, more generally, the example antenna pointing control circuitry 124, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example antenna pointing control circuitry 124 of FIG. 2 may include one or more elements, processes, and/or devices in addition to, or instead of, those illustrated in FIG. 2, and/or may include more than one of any or all of the illustrated elements, processes and devices.

FIGS. 4A-4F are block diagrams illustrating the example first repointing operation that may be performed by the antenna repointing circuitry 224 and the power analysis circuitry 226 of the example antenna pointing control circuitry 124 of FIG. 2 in response to determining that the pointing offset of the beam pointing angle of the second or MDL antenna 116 of the space vehicle 110 from the line-of-sight of the mission ground station antenna 104 does not satisfy the link margin angle θ_{mrg} (i.e., PO>θ_{mrg}, and thus, repointing is warranted). As disclosed herein, the antenna repointing circuitry 224 uses a radiation pattern-cut riding (RPCR) algorithm that correlates the RSSI values measured when the MDL antenna 116 is at different beam pointing angles with properties of a radiation pattern received by the mission ground station antenna 104. Based on the analysis, the antenna repointing circuitry 224 determines if a particular beam pointing angle of the MDL antenna 116 achieves or substantially achieves sufficient power reception (e.g., power levels that exceed the RSSI threshold T₁ or power levels that correspond to peak power) by the mission ground station antenna 104, which corresponds to alignment or substantial alignment between the beam pointing angle of the MDL antenna 116 and the line-of-sight between the MDL antenna 116 and the mission ground station antenna 104 and, thus, alignment or substantial alignment between the MDL antenna 116 and a location of the mission ground station antenna 104.

FIGS. 4A-4F show block diagrams for the RPCR algorithm 400 for radiation pattern cut associated with a first azimuth angle φᵢ. As disclosed herein, the RPCR algorithm 400 can be repeatedly executed for further iterative adjustments to the beam pointing angle at different azimuth angles (e.g., φᵢ, φᵢ₊₁). The azimuth angle φᵢ ranges from 0° to 360 degrees off the boresight 121 and orthogonally to an elevation angle θ of the gimbaled antenna 116 or space vehicle 110 (where the elevation angle refers to elevation of the antenna 116 or the space vehicle 110 starting from 90° off boresight (represented by 0°) to boresight (represented by 90°)). The azimuth angle φᵢ can be controlled by the GNC circuitry 205 for a patch antenna or the antenna pointing mechanism 228 for a gimbal antenna. For illustrative purposes, FIGS. 4A-4F will be discussed in connection with the MDL antenna 116 as a gimbaled antenna controlled by the antenna pointing mechanism 228. However, FIGS. 4A-4F can be used with examples in which the MDL antenna 116 is a patch antenna and the beam pointing angle of the patch antenna is adjusted based on control of the space vehicle attitude.

FIG. 4A is a block diagram of the example radiation pattern-cut riding (RPCR) algorithm 400 (e.g., the first repointing operation) including a slope transition (SLP_TR) block 401, a Radiation Pattern Cut Area Identifier (RPCAI) block 402, and a correction step estimator (CSE) block 404. In the example of FIG. 4, the antenna pointing mechanism 228 (FIG. 2) moves the MDL antenna 116 such that the beam pointing angle is at a first pointing angle θ. The first pointing angle θ can be determined as a result of execution of the RPCR algorithm 400 at time i to determine a first pointing angle adjustment step Δ\hat{θ}ᵢ for the beam pointing angle of the MDL antenna 116. The antenna repointing circuitry 224 executes the example RPCR algorithm 400 of FIG. 4A to determine if the first pointing angle θ of the beam pointing angle of the MDL antenna 116 results in such power received by the mission ground station antenna 104 to satisfy RSSIi>T₁ or if the pointing angle should be (further) adjusted to satisfy RSSIi>T₁, by the power levels of the signals received at the mission ground station antenna 104, which would correspond to the link margin angle θ_{mrg} being satisfied (i.e., PO≤θ_{mrg}). If the antenna repointing circuitry 224 determines, based on a comparison to threshold T₁, that the pointing angle should be further adjusted, the antenna repointing circuitry 224 determines another pointing angle adjustment step Δ\hat{θ}ᵢ₊₁ for the beam pointing angle of the gimbaled antenna 116. The antenna repointing circuitry 224 outputs the next pointing angle adjustment step Δ\hat{θ}ᵢ₊₁ for transmission to the antenna pointing mechanism 228 (FIG. 2) to control the beam pointing angle of the MDL antenna 116. The next pointing angle adjustment step Δ\hat{θ}ᵢ₊₁ is implemented at the next azimuth angle Δφᵢ₊₁ (where the next azimuth angle is controlled by the GNC circuitry 205 as discussed above).

FIG. 4B illustrates an example state machine (StM) block 406. In the example of FIG. 4B, the state machine block 406 receives an RSSI value RSSIᵢ identified by the RSSI comparator circuitry 222 of the example antenna pointing control circuitry 124 for signal(s) received by the mission ground station antenna 104 at the first time i when the beam pointing angle of the MDL antenna 116 is at the first pointing angle θ and for an azimuth angle q. At the state machine block 406 of FIG. 4B, the power analysis circuitry 226 determines a differential RSSI value ΔRSSIᵢ. For example, the power analysis circuitry 226 uses (a) an RSSIᵢ value for signals received by the mission ground station antenna 104 at time i and (b) an RSSIᵢ₋₁ value for signals received by the mission ground station antenna 104 at a second time i−1 preceding the first time i to determine a differential RSSI value ΔRSSIᵢ. In the example of FIG. 4B, the second time is a time immediately preceding the first time (e.g., RSSIᵢ₋₁ and RSSIᵢ are in succession). The RSSIᵢ₋₁ value associated with the second time i−1 preceding the first time i can be stored in, for instance, the database 232. In examples disclosed herein, the differential RSSI value ΔRSSIᵢ is indicative of a magnitude of steepness of a slope in the radiation pattern received by the mission ground station antenna 104 generated in response to receipt of signals transmitted by the MDL antenna 116 when the beam pointing angle of the MDL antenna 116 is at the first pointing angle θ.

As illustrated in FIG. 4B, the state machine block 406 generates the following outputs after comparing the RSSIᵢ value with the threshold Tᵢ and combining the result with the telemetry point Tᵢ^{(mdl)}: (a) stop repointing (SpR) if RSSIᵢ>T₁ and Tᵢ^{(mdl)}=1; (b) continue repointing (CtR) if RSSIᵢ<Tᵢ and Tᵢ^{(mdl)}=1; (c) detection of interference (DoI) if; and (d) end of interference (EoI) if RSSIi<<T₂ and Tᵢ^{(mdl)}=0. The state machine block 406 generates the following output after comparing the RSSIᵢ value with the threshold T₂ and combining the result with the telemetry point Tᵢ^{(mdl)}, namely, continue repointing (CtR₂) if RSSIᵢ<T₂ and Tᵢ^{(mdl)}=1. The state machine block 406 also generates the output Dₚ=|ΔPᵢ^{(X)}|, which represent the distance of RSSIi from T₁. Also, as disclosed above, at block 406, the antenna repointing circuitry 224 determines the differential RSSI value ΔRSSIᵢ (i.e., slope) based on the differential between two successive RSSI values. The outputs of the state machine block 406 are used to execute the radiation pattern-cut riding (RPCR) algorithm 400 of FIG. 4A.

Referring again to FIG. 4A, at the slope transition block 401, the antenna repointing circuitry 224 uses the differential RSSI value ΔRSSIᵢ to determine (e.g., predict, estimate) (a) a steepness Sᵢ at a particular spot (sampling time i) of a lobe of a radiation pattern associated with the signal(s) received by the mission ground station antenna 104 and (b) whether the slope is ascending or descending (e.g., aᵢ/dᵢ).

FIG. 4C illustrates an example implementation of the slope transition (SLP_TR) block 401 of FIG. 4A. In the example of FIG. 4C, the differential RSSI value ΔRSSIᵢ is provided as an input to a slope extractor block 408. Also, the differential RSSI value ΔRSSIᵢ for the preceding time (e.g., the second time i−1) is provided as an input to the slope extractor block 408. The antenna repointing circuitry 224 uses the differential RSSI values ΔRSSIᵢ and ΔRSSIᵢ₋₁ to determine (e.g., estimate) (a) a steepness Sᵢ, Sᵢ₋₁ of a lobe of a radiation pattern associated with the signal(s) received by the mission ground station antenna 104 at time instants i, i−1 and (b) whether the direction is ascending or descending the lobe (e.g., aᵢ/dᵢ, aᵢ₋₁/dᵢ₋₁).

FIG. 4D illustrates an example implementation of the slope extractor block 408 of FIG. 4C. In the example of FIG. 4D, the power analysis circuitry 226 determines, based on the power analysis rule(s) 234 and the differential RSSI value ΔRSSIᵢ, a steepness of a slope of a portion of the radiation pattern (block 409) and a sign associated with the slope, namely, ascending or descending (block 411). The outputs of the slope extractor block 408 include the slope steepness Sᵢ and the slope sign, namely, aᵢ (ascending) or dᵢ (descending). Thus, in examples disclosed herein, the differential RSSI values are translated into representations of slopes in the radiation pattern received by the mission ground station antenna 104 when the beam pointing angle of the gimbaled antenna 116 is at the first pointing angle θ.

Referring again to FIG. 4A, the outputs of the slope transition block 401 include the steepness Sᵢ and the slope sign aᵢ/dᵢ associated with the ΔRSSIᵢ, value for the time i and the steepness Sᵢ₋₁ and the slope sign aᵢ₋₁/dᵢ₋₁ associated with the ΔRSSIᵢ₋₁ value for the second time i−1. In the example of FIG. 4A, at the Radiation Pattern Cut Area Identifier (RPCAI) block 402, the power analysis circuitry 226 can use the rule(s) defined in Table 1, above, to analyze the slope patterns and to determine whether, for instance, the slope patterns are indicative of traversing a lobe of the radiation pattern, traversing a peak, approaching a peak, etc. As a result of the Radiation Pattern Cut Area Identifier (RPCAI) analysis (block 402), the power analysis circuitry 226 determines if RSSIᵢ≥T₁ has been achieved as a result of pointing the beam of the MDL antenna 116 at the first pointing angle θ. Based on the RPCAI analysis, the radiation pattern-cut riding (RPCR) algorithm outputs an indicator of whether or not peak power has been found (i.e., peak power found (PPF)=1 when RSSIᵢ>T₁) or peak power not found (PPF=0).

At the correction step estimator block 404 of FIG. 4A, the antenna repointing circuitry 224 determines (another) pointing angle adjustment step Δ\hat{θ}ᵢ₊₁, which represents an angle (e.g., degree(s)) by which the beam pointing angle of the MDL antenna 116 should be adjusted via the antenna pointing mechanism 228 in a subsequent iteration i+1.

FIG. 4E illustrates an example implementation of the correction step estimator (CSE) block 404 of FIG. 4A. In the example of FIG. 4E, a slope extraction (block 408) is performed to determine the steepness Sᵢ and the slope sign aᵢ/dᵢ. The slope extraction can be the same or substantially the same as the slope extraction disclosed in connection with FIG. 4D.

In the example of FIG. 4E, the antenna repointing circuitry 224 uses the steepness Sᵢ and the slope sign aᵢ/dᵢ values to determine the pointing angle adjustment step Δ\hat{θ}ᵢ₊₁. For example, at block 410, the antenna repointing circuitry 224 performs a slope-to-angle (S2A) analysis, which is further disclosed in connection with FIG. 4G. The slope-to-angle analysis can be performed based on the antenna pointing rule(s) 231. As shown in FIG. 4F, the antenna repointing circuitry 224 determines that the steepness Sᵢ exceeds a threshold (e.g., defined by antenna pointing rule(s) 231) and is ascending (i.e., aᵢ). In such examples, the antenna repointing circuitry 224 determines that the pointing angle adjustment step Δ\hat{θ}ᵢ₊₁ should be smaller than the prior pointing angle adjustment step Δ\hat{θ}ᵢ (i.e., the pointing angle adjustment step that resulted in the beam pointing angle of the MDL antenna 116 being at the first pointing angle θ). In particular, the antenna repointing circuitry 224 determines that the pointing angle adjustment step Δ\hat{θ}ᵢ₊₁ should be smaller than the prior pointing angle adjustment step Δ\hat{θ}ᵢ because the RSSI value RSSI; indicates that the first pointing angle θ is nearing peak power reception in one axis for an azimuth angle φ=φᵢ (or pattern cut) as measured by the mission ground station antenna 104. As such, the antenna repointing circuitry 224 determines that the pointing angle should be refined (e.g., moved by smaller amounts) in view of potentially approaching peak power rather than causing the pointing angle to change by a larger amount. In some examples, the antenna repointing circuitry 224 analyzes an average of slope patterns over a time period to determine the pointing angle adjustment step (e.g., to account for noise or other variations in slope properties). In some examples the adjustment step is scaled by the distance Dₚ of RSSIᵢ from T₁, a shown in FIG. 4G (e.g., kDₚΔ\hat{θ}ᵢ).

In some examples, the antenna repointing circuitry 224 determines that the steepness Sᵢ exceeds the threshold and is descending (i.e., dᵢ). In such examples, the antenna repointing circuitry 224 determines that the pointing angle adjustment step Δ\hat{θ}ᵢ₊₁ should be larger than the prior pointing angle adjustment step Δ\hat{θ}ᵢ (e.g., because further analysis and adjustment is likely needed to achieve peak power as the received power is distancing from the peak power).

In some examples, the antenna repointing circuitry 224 determines that the steepness is less than the threshold. In such examples, the antenna repointing circuitry 224 determines that the pointing angle adjustment step Δ\hat{θ}ᵢ₊₁ should be less than the prior pointing angle adjustment step Δ\hat{θ}ᵢ. For instance, if the power analysis circuitry 226 determines that the slope is indicative of a noise floor, then the antenna repointing circuitry 224 determines that a larger pointing angle correction should be applied so that the next sensed RSSI value will not be from the noise floor, but will correspond to one of the lobes of the radiation pattern rather than the noise floor.

Thus, in the example RPCR algorithm of FIGS. 4A-4F, the antenna repointing circuitry 224 analyzes two successive RSSI values at a first time i and a second time i−1 and correlates the RSSI values with slope properties of the radiation pattern. The antenna repointing circuitry 224 determines a further iteration to adjust the pointing angle of the MDL antenna 116 to align or substantially align the beam pointing angle of the gimbaled antenna 116 and the line-of-sight between the MDL antenna 116 and the mission ground station antenna 104 and, thus, to facilitate alignment between the MDL antenna 116 and the mission ground station antenna 104. The output of the example RPCR algorithm of FIGS. 4A-4F includes a value of the pointing angle adjustment step Δ\hat{θ}ᵢ₊₁ (e.g., the next iteration in the adjustment of the pointing angle) based on analysis of the RSSI values and the telemetry point Tᵢ^{(mdl)}. Thus, the antenna repointing circuitry 224 iteratively determines adjustments to the pointing angle of the MDL antenna 116 to direct and/or refine the pointing angle to satisfy RSSIᵢ≥T₁ and, therefore, meet the link margin angle θ_{mrg} (i.e., PO≤θ_{mrg}) and provide for sufficient power reception (e.g., peak power reception, or RSSI satisfies or crosses the threshold T₁) at the mission ground station antenna 104. For instance, as the power RSSIᵢ approaches the power threshold T₁ (as identified by the state machine block 406 in FIG. 4B), then the antenna repointing circuitry 224 determines that a smaller change in the pointing angle adjustment step Δ\hat{θ}ᵢ₊₁ is warranted to refine the pointing angle as compared to when there is a larger offset between the power RSSIi and the threshold T₁ and larger changes in the pointing angle may be warranted (shown by block 410 of FIG. 4F).

As disclosed herein, in some examples, during execution of the peak power searching algorithm (i.e., the analysis of the local maximum power levels to identify the global peak power), the power analysis circuitry 226 determines that the RSSI threshold T₁ has been reached (e.g., one of the lobes of the radiation pattern is crossed by the RSSI threshold T₁ such that RSSIᵢ≥T₁). In such examples, because the RSSI threshold T₁ has been met at a particular beam pointing angle, the power analysis circuitry 226 determines that the link margin angle θ_{mrg} has been satisfied. In some examples, the power analysis circuitry 226 continues to search for achievement of peak power. In some examples, the power analysis circuitry 226 implements auto-tracking and auto-pointing in connection with attempting to align the boresight axis 121 of the MDL antenna 116 with the boresight axis of the mission ground station antenna 104. In some examples, the power analysis circuitry 226 implements a 2D RPCR optimization algorithm (e.g., based on adjustments to elevation and azimuth angles of the space vehicle 110) or a 1D RPCR optimization algorithm (e.g., based on adjustment to azimuth angles of the space vehicle 110) in connection with analyzing received power levels relative to peak power.

For example, in connection with the radiation pattern graph 416 of FIG. 4G and execution of a 2D RPCR optimization algorithm 400 by the power analysis circuitry 226, assume T^{(X)}>Pₚₖ^{(X)}→search for (X),where Pₚₖ^{(X)} stands for the received power's global peak, is optimal but cannot be achieved to close the mission data link between the space vehicle 110 and the ground entry point (mission ground station antenna 104). Rather, in connection with the radiation pattern 418 of FIG. 4H, if T^{(X)}<Pₚₖ^{(X)}→search for Pₚₖ^{(X)}, the power analysis circuitry 226 either (a) determines that repointing of the beam pointing angle should stop P_{Rx}^{(X)}>T^{(X)}, where P_{Rx}^{(X)}<Pₚₖ^{(X)}, or (b) determines that the repointing should continue and the power analysis circuitry 226 continues to search for the Pₚₖ^{(X)} till found, i.e., P_{Rx}^{(X)}=Pₚₖ^{(X)} for maximum available link margin.

For example, assume that Tₐᵤₜₒ^{(GS)} auto is the received power level at which the ground station auto-tracking is obtaining “locked” status (e.g., the mission ground station antenna 104 automatically tracks based on differential power in two axes); if the power level threshold above which the link margin is met is T^{(X)}>Tₐᵤₜₒ^{(GS)}, then obtaining the correct auto-pointing of the space vehicle MDL antenna 116 also secures successful auto-tracking at the mission ground station antenna 104. In general choosing T^{(X)}>Tₐᵤₜₒ^{(GS)} provides that auto-tracking by the mission ground station antenna 104 will be achieved and activated first so that the process of obtaining auto-pointing of the MDL antenna 116 of the space vehicle 110 can assume an active auto-tracking of the space vehicle 110 by the mission ground station antenna 104.

For example, in connection with the radiation pattern graph 420 of FIG. 4I, if T^{(X)}>Tₐᵤₜₒ^{(GS)} and P_{Rx}^{(X)}<Tₐᵤₜₒ^{(GS)}, then auto-tracking by the mission ground station antenna 104 is OFF, and instead, (TLE)-based (programmable tracking by the mission ground station antenna 104) auto-pointing is ON (while in state 308 in FIG. 3, where TLE refers to Two Line Element Set that provides commonly accepted directional knowledge for a ground station to track a satellite) until P_{Rx}^{(X)}+ΔP_{Rx}^{(X)}>Tₐᵤₜₒ^{(GS)} and then auto-tracking by the mission ground station antenna 104 turns ON.

If T^{(X)}>Tₐᵤₜₒ^{(GS)} and Tₐᵤₜₒ^{(GS)}<P_{Rx}^{(X)}<T^{(X)}, then auto-tracking by the mission ground station antenna 104 is ON and this triggers the space vehicle antenna auto-pointing algorithm for the MDL antenna 116 to be ON (e.g., state 308 in FIG. 3).

If T^{(X)}>Tₐᵤₜₒ^{(GS)} and P_{Rx}^{(X)}>T^{(X)}, then auto-tracking by the mission ground auto station antenna 104 is ON, and continuation of auto-pointing of the MDL antenna 116 is optional (e.g., state 300 of FIG. 3) if desired to reach received power global peak Pₚₖ^{(X)} and obtain maximum available margin.

As another example, if T^{(X)}<Tₐᵤₜₒ^{(GS)} and P_{Rx}^{(X)}>Tₐᵤₜₒ^{(GS)}, then auto-tracking by the mission ground station antenna 104 is ON, auto-pointing of the MDL antenna 116 is at state 300 of FIG. 3, and continuation of auto-pointing of the MDL antenna 116 is optional for attempting to achieve maximum available link margin.

If T^{(X)}<Tₐᵤₜₒ^{(GS)} and T^{(X)}<P_{Rx}^{(X)}<Tₐᵤₜₒ^{(GS)}, then auto-tracking by mission ground station antenna 104 is OFF, auto-pointing of the MDL antenna 116 is at state 300 of FIG. 3, and TLE-based continuation of auto-pointing of the mission ground station antenna 104 is available. If continue to seek for global max power peak P_{Rx}^{(X)}>Tₐᵤₜₒ^{(GS)}, then when P_{Rx}^{(X)}>Tₐᵤₜₒ^{(GS)}, then auto-tracking by the mission ground station antenna 104 turns ON.

If T^{(X)}<Tₐᵤₜₒ^{(GS)} and P_{Rx}^{(X)}<T^{(X)}, then auto-tracking by mission ground station auto antenna 104 is OFF, auto-pointing of the MDL antenna 116 is at state 308 of FIG. 3, and the auto-pointing by the mission ground station antenna 104 is TLE-based.

In connection with execution of a 1D RPCR optimization algorithm by the power analysis circuitry 226, if T^{(X)}>Pₚₖ_{ᵢ}^{(X)} where Pₚₖ_{ᵢ}^{(X)} stands for the received peak power of a single pattern cut corresponding to a specific azimuth angle φᵢ, out of the total 3D received power surface, then the 1D RPCR optimization algorithm will, after finding that local peak Pₚₖ_{ᵢ}^{(X)}, output instructions for continued repointing (CtR) to seek the peak power corresponding to a pattern cut of another azimuth angle φᵢ₊₁=φᵢ+Δφᵢ (where Δφᵢ is 360 degrees or the half power beamwidth of the antenna at the given frequency).

In some examples, the power analysis circuitry 226 seeks the received power to exceed the threshold P_{Rx}^{(X)}>T^{(X)}: This may be sufficient to satisfy, for example, at least a 3 dB link margin. In this example, the RPCR algorithm is not seeking for the absolute global peak of the received power Pₚₖ^{(X)}, but instead, seeks for RSSI to exceed the threshold T^{(X)}. Once RSSI exceeds T^{(X)}, the RPCR algorithm will stop searching for Pₚₖ^{(X)} and the system state will be at state 300 of FIG. 3.

In some examples, the power analysis circuitry 226 seeks the global maximum of the received power Pₚₖ^{(X)}, i.e., obtaining maximum available link margin. In such examples, after reaching a local peak Pₚₖ_{ᵢ}^{(X)} that exceeds T^{(X)}, then the RPCR algorithm continues seeking for the global peak Pₚₖ^{(X)} for all slices/pattern cuts at all azimuth angles φᵢ.

FIG. 5A is a block diagram of the example system 100 of FIGS. 1 and 2 showing the analysis performed by the antenna pointing control circuitry 124 to determine whether the beam pointing angle of the MDL antenna 116 should be adjusted to align or substantially align the boresight axis 121 with the line of sight between the MDL antenna 116 and the mission ground station antenna 104 of FIG. 1. In the example of FIG. 5A, the antenna pointing control circuitry 124 is implemented at the ground by the ground and mission control circuitry 112. Thus, in this example, algorithms are executed to determine RSSI and the pointing adjustment step at the ground. The example analysis performed by the antenna pointing control circuitry 124 represented in FIG. 5A is further disclosed in connection with the flowcharts of FIGS. 6-8.

In FIG. 5A and Table 2, Tᵢ^{(mdl)} represents a telemetry point representing the transmission activity status of the gimbaled antenna 116 at time i. Further, Table 2, below, includes the following conditions included in FIG. 5A.

TABLE 2

| Condition | Explanation |
|---|---|
| RSSIᵢ > T₁ | θ < θ_{mrg} |
| RSSIᵢ < T₂ | θ > θₘₐₓ |
| SpR = RSSIᵢ > T₁ & Tᵢ^{(mdl)} | Stop repointing, link margin |
| | angle (θ_{mrg}) satisfied (PO ≤ |
| | θ_{mrg}) |
| CtR = (T₂ < RSSIᵢ < T₁) & Tᵢ^{(mdl)} | Continue repointing: RSSI is |
| | measured at the mission ground |
| | station antenna 104; θ_{mrg} not |
| | yet satisfied |
| DoI = (RSSIᵢ > T₂) & T̅ᵢ^{(mdl)} | Detection of Interference |
| CtR2 = (RSSIᵢ < T₂) & Tᵢ^{(mdl)} | Large PO that exceeds |
| | maximum off-pointed angle |
| | (PO > θₘₐₓ), continue |
| | repointing to first satisfy θₘₐₓ |
| | and then to satisfy θ_{mrg} (i.e., |
| | two-step process) |
| Intᵢ₋₁ & I̅n̅t̅ᵢ⇒ RT | Detection of end-of-interference |
| EoI = (RSSIᵢ < T₂) & T̅ᵢ^{(mdl)} | (EoI) |

FIG. 5A also illustrates message authentication analysis performed by the signal authentication circuitry 216 (e.g., the pre-authentication circuitry 217, the post-authentication circuitry 219) and data decryption circuitry 218 (FIG. 2) of the example ground station control circuitry 212. As shown in FIG. 5A, if the telemetry detection circuitry 220 (FIG. 2) determines that the MDL antenna 116 is transmitting data and SpR=1, but the post-authentication circuitry 219 determines that the received message is invalid, the antenna repointing circuitry 224 generates instructions that are transmitted via the TTC ground station antenna 108 and instruct the vehicle control circuitry 204 to re-transmit the message or, otherwise, to send a next message (i.e., in FIG. 5A: if (Tᵢ₋₁^{(mdl)} & ReTx) m=mᵢ₋₁, else m=mᵢ). In some examples, retransmission of the message will have an upper bound on the number of retransmissions allowed (e.g., in view of factors such as on-board data storage capacity). If RSSIᵢ>T₁ and the signal authentication circuitry 216 authenticates the message while there is no active transmission by the MDL antenna 116, the antenna repointing circuitry 224 generates instructions to cause the MDL antenna 116 to stop transmitting data and the mission ground station antenna 104 to stop receiving data because of the risk of interference or hacking (i.e., DoI or DoH⇒STI in FIG. 5A, where DoH=DoI & Y, where Y indicates that the message mᵢ has been authenticated by the post-authentication circuitry 219, and DoI or DoH⇒SRI in FIG. 5A, where STI represents causing the MDL antenna 116 (i.e., an MDL transmitter 500 associated with the MDL antenna 116) to enter an idle state and SRI represents causing the mission ground station antenna 104 (receiver) to enter an idle state). In some examples, in cases of DoI (detection of interference) or DoH (detection of hacking), instead of causing the MDL antenna 116 (i.e., the MDL transmitter 500 associated with the MDL antenna 116) to enter an idle state, the antenna repointing circuitry 224 generates instructions for the MDL antenna 116 to increase its radio frequency (RF) output power or to reduce its data transmission rate.

In examples in which the MDL antenna 116 and the mission ground station antenna 104 (e.g., a receiver of the mission ground station antenna 104) enter an idle state, the mission ground station antenna 104 periodically (e.g., every few minutes) exits the idle state (e.g., wakes up) and checks for the end of interference (EoI) (i.e., RSSIᵢ<<T₂ for M samples and Tᵢ^{(mdl)}=0 (because the MDL antenna 116 is still idle). When the signal authentication circuitry 216 detects (RSSIᵢ<T₂) & (Tᵢ^{(mdl)}=0), then the antenna repointing circuitry 224 generates instructions for the MDL antenna 116 to resume transmission (i.e., EoI⇒RT in FIG. 5A). Also, when the mission ground station antenna 104 was idle at time i−1 and the current telemetry status of the MDL antenna 116 indicates active transmission (i.e., Tᵢ^{(mdl)}=1) and end of interference (EoI) has been detected, the antenna repointing circuitry 224 generates instructions for the mission ground station antenna 104 to resume data reception (S̅_{R}_{ₓ}_{,i-1}^{mdl}EoI⇒RR in FIG. 5A). In some examples, the mission ground station antenna 104 remains on (e.g., always on) and monitors (e.g., continuously or substantially continuously) for detections of end of interference (EoI).

In some examples, the receiver of the mission ground station antenna 104 or of the space vehicle 110 (e.g., the MDL antenna 116 as a receiver) saves the last orbital state of the space vehicle 110 before entering the idle state. While the MDL antenna 116 is in the idle state, an estimated orbital state evolution is generated by an orbital propagator of the space vehicle 110. When the MDL antenna 116 and the mission ground station antenna 104 exit the idle state, the new orbital state of the space vehicle 110 can be based on (1) the last saved orbital state and (2) the estimated orbital state evolution, or it can be provided by GPS of the space vehicle 110.

Further, although the example of FIG. 5A shows the MDL antenna 116 as including the MDL transmitter 500, as noted above, in some examples, the MDL antenna 116 includes a transceiver. The transmitter or transceiver status of the MDL antenna 116 can affect location of power sensing (RSSI) measurements and interference detection capabilities. For example, with respect to RSSI power sensing, when the MDL antenna 116 includes a transmitter 500 only, then sensors for power measurement sensing (RSSI) are located at the mission ground station antenna 104. Also, interference detection takes place at the mission ground station antenna 104 and based on telemetry data from the first (TTC) antenna 114. In examples in which the MDL antenna 116 includes a transceiver, there are sensors for power measurements (RSSI) at the space vehicle 110 and the mission ground station antenna 104. In some such examples, power (RSSI) measurements can take place only onboard the space vehicle 110; in such examples, interference detection can be performed at the space vehicle 110 based on telemetry data from the first (TTC) antenna 114. In other examples in which the MDL antenna 116 includes a transceiver, the power (RSSI) measurements can occur onboard the space vehicle 110 and at the mission ground station antenna 104. In such examples, interference detection can be performed at the space vehicle 110 and at the mission ground station antenna 104 based on telemetry data from the first (TTC) antenna 114. Table 3, below, summarizes the different sensing scenarios based on whether the MDL antenna 116 is associated with a transmitter (e.g., the transmitter 500) or a transceiver.

TABLE 3

| Telemetry Point | Power Sensing (RSSI measurement) | |
|---|---|---|
| TTC (S-band) or | MDL Tx only | MDL Tx/Rx |

| | | | |
|---|---|---|---|
| MDL (C, X-band) | | | |
| With Interference | GS, TTC | SV, TTC | SV & |
| Detection | | | GS, |
| Capability | | | TTC |
| Without | — | SV, MDL | SV & |
| Interference | | | GS, |
| Detection | | | MDL |
| Capability | | | |

FIG. 5B is a block diagram illustrating communication between the MDL antenna 116 of the space vehicle 110 (and the mission ground station antenna 104 and between the first (e.g., hemispherical) antenna 114 of the space vehicle 110 and the TTC ground station antenna 108 of FIG. 1 with respect to receiving signals from the MDL antenna 116 of the space vehicle, where the signals have as an associated signal strength RSSI (e.g., P^{(x)} in FIG. 5B). Also, the telemetry point Tᵢ^{(mdl)} is received from the space vehicle (e.g., the hemispherical antenna 114 of FIG. 1) via the telemetry downlink (DL) data 206 received by the TTC ground station antenna 108. In examples in which the antenna pointing control circuitry 124 is implemented at the ground, the antenna pointing control circuitry 124 can determine the adjustment step Δ\hat{θ} to the beam pointing angle and send the adjustment step to the space vehicle via the command uplink (UL) data 202. In examples in which the antenna pointing control circuitry 124 is implemented at the space vehicle, the antenna pointing control circuitry 124 can receive RSSI data and use the telemetry point Tᵢ^{(mdl)} locally generated at the space vehicle 110 and the RSSI data to determine the adjustment step Δ\hat{θ}. As shown in FIG. 5B, the MDL antenna 116 can communicate with the mission ground station antenna 104 via the X or K bands. The telemetry point Tᵢ^{(mdl)} can be received via the L or S bands. Also, the command uplink (UL) data 202 (e.g., including the RSSI data for use by the antenna pointing control circuitry 124 at the space vehicle or the adjustment step Δ\hat{θ} determined by the antenna pointing control circuitry 124 at the ground) can be transmitted via the L or S bands, each of which may provide for higher transmission reliability relative to other bands. In examples in which the MDL antenna 116 of the space vehicle 110 includes a transceiver (i.e., not just a transmitter), the RSSI values can be generated (e.g., measured) locally on-board the space vehicle 110. Also, in examples in which the MDL antenna 116 includes a transceiver, the adjustment step Δ\hat{θ} can be determined at the space vehicle 110 in response to, for example, the RSSI measurements performed at the space vehicle 110 or in response to uplink data from the TTC ground station antenna 108 indicating that the beam pointing angle of the MDL antenna 116 should be adjusted (e.g., based on RSSI measurements performed at the ground).

FIG. 5C is a block diagram illustrating example logic 502 that may be implemented by the antenna pointing control circuitry 124 in connection with controlling a pointing angle of a beam of the antenna of the space vehicle (e.g., as detailed in connection with FIG. 5A). As illustrated in FIG. 5C, the antenna pointing control circuitry 124 uses the telemetry point Tᵢ^{(mdl)}, received power or RSSI variable P^{(x)} and the power level threshold T₁ to determine whether to adjust the pointing angle of the MDL antenna 116 via the antenna pointing mechanism 228 and/or via adjustments to the attitude of the space vehicle 110 (e.g., via outputs of the GNC circuitry 205), to identify interference, etc. In the example of FIG. 5C, MOPS refers to mission operations (e.g., in connection with command and control of the space vehicle 110). Although example FIG. 5C is discussed in connection with the X-band, the logic 502 of FIG. 5C may be implemented in connection with other bands.

Some examples disclosed herein are discussed in connection with the telemetry point of the MDL transmitter 500 activity status, sent via the S-band channel, serving as an indicator of the presence of the mission data signal when the MDL antenna 116 has a pointing offset from its line-of-sight with the mission ground station antenna 104, implying a weaker signal that could fall under the receiver's noise level (i.e., RSSIᵢ<T₁ and Tᵢ^{(mdl)}=1). In some examples, a dual condition can apply (i.e., RSSIᵢ>T₂ and Tᵢ^{(mdl)}=0), which implies a presence of interference. However, interference will not show up during non-transmitting periods for the MDL antenna 116. In some such examples, interference spectrally overlaps with the mission signal of interest, which can imply higher power levels than the average (i.e., RSSIᵢ>>T₁). In this example, an interference detecting condition can be defined as: RSSIᵢ>>T₁ & Tᵢ (mdl)=1. To determine whether interference is present together with the mission signal of interest, transmission by the MDL antenna 116 can be interrupted (e.g., for very short time (ms, or μs) such that Tᵢ^{(mdl)}=0. In such examples, the antenna pointing control circuitry 124 determines if RSSIᵢ>T₂ or RSSIᵢ≈T₂. If RSSIᵢ>T₂ or RSSIᵢ≈T₂, then the antenna pointing control circuitry 124 addresses presence of interference, as discussed in connection with FIG. 7.

Table 4, below, summarizes two approaches with respect to evaluating whether a pointing adjustment should be performed and detected possible interference, namely, adjusting the pointing direction±PO of the MDL antenna 116 (in azimuth for example) and (2) changing the MDL transmitter activity status from Tᵢ^{(mdl)}=1, to Tᵢ^{(mdl)}=0:

TABLE 4

| Tᵢ^{(mdl)} = 1 | | Tᵢ^{(mdl)} = 0 | | |
|---|---|---|---|---|
| | RSSIᵢ ± | | RSSIᵢ ± | |
| RSSIᵢ | PO (az for ex.) | RSSIᵢ | PO (az for ex.) | Conclusion |
| Pₚₖ > | direction- | <<T₂ | — | No pointing |
| T₁ | independent | | | adjustment |
| | | | | needed |
| >T₁ | direction- | <<T₂ | — | No pointing |
| | dependent | | | adjustment |
| | | | | needed |
| >>T₁, | direction- | <T₁ | direction- | Possibility |
| or > | dependent | & >0 | dependent | of: signal + |
| Pₚₖ > | | | | interference; |
| T₁ | | | | directional |
| | | | | interference |
| | | | | present |
| <<T₂ | <<T₂ (unchanged) | <<T₂ | <<T₂ (unchanged) | Thermal |
| | | | | noise only |

FIG. 6 is a flowchart representative of example machine readable instructions and/or example operations 600 that may be executed, instantiated, and/or performed by programmable circuitry to control a beam pointing angle of the second or MDL antenna 116 (e.g., a gimbaled antenna, a patch antenna) of the example space vehicle 110 of FIGS. 1 and 2. The example machine-readable instructions and/or the example operations 600 of FIG. 6 begin at block 602, at which the beam of the MDL antenna is at a first pointing angle θ.

At block 604, the telemetry detection circuitry 220 of the example antenna pointing control circuitry 124 of FIG. 2 determines a transmission status (i.e., Tᵢ^{(mdl)}) of the MDL antenna 116. (As noted herein, the transmission status can represent a status of the associated MDL transmitter 500 of FIG. 5A, where when the transmission status of the MDL transmitter 500 is on, then the transmission status of the MDL antenna 116 is also on). In examples disclosed herein, the telemetry detection circuitry 220 determines the transmission status of the gimbaled antenna 116 based on telemetry data transmitted by the first, hemispherical antenna 114 of the space vehicle 110 and received at the TTC ground station antenna 108.

At block 606, the RSSI comparator circuitry 222 of the example antenna pointing control circuitry 124 of FIG. 2 performs a comparison of the RSSI measurement (e.g., RSSIᵢ) of the signals transmitted by the MDL antenna 116 and received at the mission ground station antenna 104 when the beam of the MDL antenna 116 is at the first pointing angle θ to the threshold RSSI value(s) 230 (e.g., T^{(X)}, T₁, T₂).

At block 608, the antenna repointing circuitry 224 of the example antenna pointing control circuitry 124 of FIG. 2 determines a system state (e.g., from FIG. 3) for the MDL antenna 116 and the mission ground station antenna 104 based on the transmission activity status of the MDL antenna 116 and the comparison of the RSSI value to the threshold RSSI value(s) 230. For example, the antenna repointing circuitry 224 determines the values for the variables in the state vector defined as [Tᵢ^{(mdl)}, TRSSIᵢ, (PO)] as disclosed in connection with FIG. 3. Based on the values assigned to the variables Tᵢ^{(mdl)} and TRSSIᵢ (e.g., 0 or 1) by the telemetry detection circuitry 220 and the RSSI comparator circuitry 222, the antenna repointing circuitry 224 identifies the system state (e.g., one of the states represented by the blocks 300, 302, 306, 308 in FIG. 3).

If, at block 610, the antenna repointing circuitry 224 determines that the system state indicates a likelihood of interference and/or hacking (e.g., [Tᵢ^{(mdl)}, TRSSIᵢ, (PO)]=[0, 1,−]), then control proceeds to block 612 (further disclosed in FIG. 7) to address the risk of interference such as jamming or hacking (e.g., where hacking is detected based on interference detection (i.e., DoI & Y⇒DoH in FIG. 5A) but no transmission from the MDL antenna 116 (i.e., Tᵢ^{(mdl)}=0). Control returns to block 604 when the risk of interference or hacking has been resolved.

If no interference or hacking has been detected, then at block 614, the antenna repointing circuitry 224 determines if the system state indicates the pointing angle of the MDL antenna 116 should be adjusted (e.g., [Tᵢ^{(mdl)}, TRSSIᵢ, (PO)]=[1, 0, (1)]) because RSSIᵢ<T₁ and Tᵢ^{(mdl)}=1, implying that the pointing offset of the boresight axis 121 of the MDL antenna 116 from the line-of-sight between the MDL antenna 116 and the mission ground station antenna 104 does not satisfy a first angular threshold, namely, the link margin angle (e.g., PO>θ_{mrg}). If the antenna repointing circuitry 224 determines that no repointing of the MDL antenna 116 is warranted, then control proceeds to block 622 for continued monitoring (e.g., in response to (a) adjustments to the attitude of the space vehicle and resulting effects on a gimbaled MDL antenna 116, or (b) possible errors in the space vehicle's location estimation due to lack of GPS information (e.g., malfunctioning, outage, etc.)).

If the antenna repointing circuitry 224 determines that the beam pointing angle of the MDL antenna 116 should be adjusted (e.g., because PO>θ_{mrg}), then at block 616, the antenna repointing circuitry 224 determines, via the RSSIᵢ comparisons, if the pointing offset of the beam pointing angle of the gimbaled antenna 116 from the boresight axis 121 exceeds a second angular threshold, namely, the maximum angle θₘₐₓ (i.e., RSSIᵢ<T₂) and, thus, violates spectrum management policies. For example, the antenna repointing circuitry 224 determines that the pointing offset exceeds the maximum angle θₘₐₓ based on the comparison of the RSSI value to the threshold RSSI value(s) 230 (e.g., PO>θₘₐₓ when RSSIᵢ<T₂).

If the antenna repointing circuitry 224 determines that the pointing offset exceeds the maximum angle θₘₐₓ, then at block 618, the antenna repointing circuitry 224 executes a repointing algorithm to cause the pointing offset to satisfy the maximum angle θₘₐₓ (e.g., PO≤θₘₐₓ). For example, the antenna repointing circuitry 224 can use star tracker vehicle orientation and calibration data (e.g., computed dish boresight pointing and offset relative to the mission ground station 104) to so that the pointing offset satisfies PO≤θₘₐₓ.

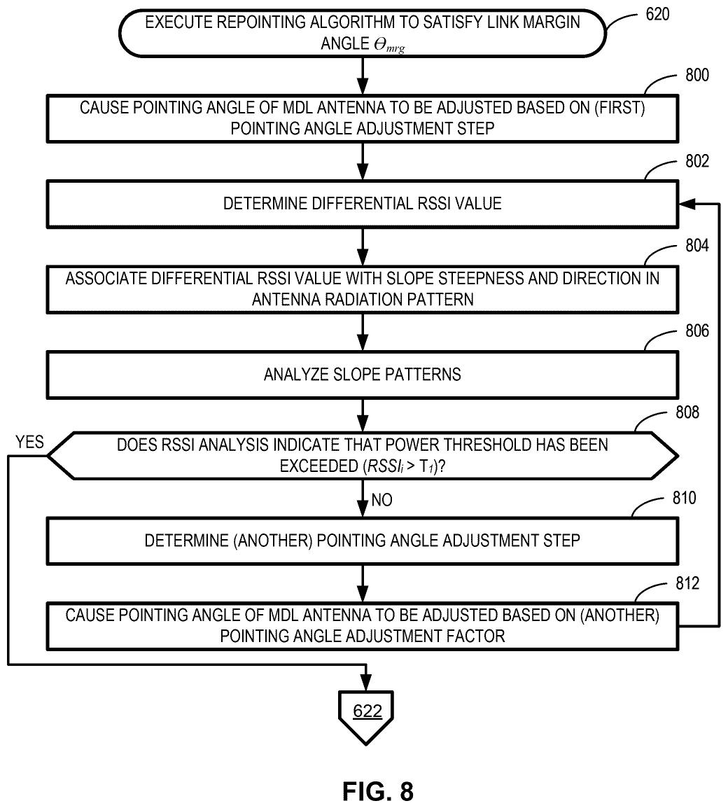

In the example of FIG. 6, if the antenna repointing circuitry 224 determines that the pointing offset does not exceed the maximum angle θₘₐₓ or after the repointing algorithm has been executed at block 618 so that the pointing offset satisfies maximum angle θₘₐₓ, control proceeds to block 620. At block 620, the antenna repointing circuitry 224 and power analysis circuitry 226 of the example antenna pointing control circuitry 124 of FIG. 2 execute another repointing algorithm to adjust the beam pointing angle of the MDL antenna 116 so that pointing offset satisfies the link margin angle θ_{mrg} (i.e., PO≤θ_{mrg}) and threshold T₁ has been exceeded (i.e., RSSIᵢ>T₁), as further disclosed in connection with FIG. 8. Control ends at block 622 with continued monitoring (e.g., in response to adjustments to the attitude of the space vehicle and resulting effects on a gimbaled MDL antenna 116 or location error estimates due to, for example, lack of GPS information).

FIG. 7 is a flowchart representative of example machine readable instructions and/or example operations that may be executed, instantiated, and/or performed by programmable circuitry to implement block 612 of FIG. 6 to address interference, such as jamming or hacking, with respect to the system 100 of FIGS. 1 and/or 2 in response to a determination at block 610 of FIG. 6 that the system state (e.g., as defined in FIG. 3) is indicative of interference or hacking. The telemetry detection circuitry 220 recognizes that the MDL antenna 116 is not currently transmitting data, and, thus, at block 702, the antenna repointing circuitry 224 instructs, via the command uplink data 202 transmitted by the TTC ground station antenna 108 to the space vehicle 110 via the first antenna 114, the MDL antenna 116 to not resume data transmission (or further transmissions of data) ((S_{T}_{_{x,i}}^{mdl}=0 (STI) in FIG. 5A). Also, at block 704, the antenna repointing circuitry 224 instructs (e.g., via the ground station control circuitry 212), the mission ground station antenna 104 to refrain from receiving data to prevent receipt of intended or unintentional interference, such as injection of false data or eavesdropping of data (S_{R}_{_{x,i}}^{mdl}=0 (SRI)) in FIG. 5A).

Continuing from block 702, in some examples, at block 706, the antenna repointing circuitry 224 can cause an optional calibration process to be performed (e.g., as represented by arrow 304 and block 306 in FIG. 3), when feasible, in which the beam pointing angle of the gimbaled antenna 116 is adjusted so that the beam pointing angles of the gimbaled antenna 116 and the mission ground station antenna 104 are aligned or substantially aligned when communication between the space vehicle 110 and the mission ground station antenna 104 resumes.

At block 708, the telemetry detection circuitry 220 determines if the risk of interference (e.g., jamming, hacking) has ended (i.e., if RSSIᵢ<T₂ and Tᵢ^{(mdl)}=0). Block 708 can be implemented in response to the antenna repointing circuitry 224 instructing the mission ground station antenna 104 to refrain from receiving data at block 704 (however, when the receiver of the mission ground station antenna 104 is set to idle, the receiver can still produce RSSI measurements (e.g., by periodically exiting the idle state) to enable a determination of end of interference). Once the interference or hacking risk has been resolved (i.e., RSSIᵢ<T₂ and Tᵢ^{(mdl)}=0), then at block 710, the antenna repointing circuitry 224 instructs, for instance, via the ground station control circuitry 212, the mission ground station antenna 104 to resume reception (RR in FIG. 5A) of signals. Also, at block 712, the antenna repointing circuitry 224 instructs, via the command uplink data 202 transmitted by the TTC ground station antenna 108 to the space vehicle 110, the MDL antenna 116 to resume transmission (RT in FIG. 5A) of data. Control returns to block 604 of FIG. 6. Referring again to block 708, if control determines that RSSIᵢ>T₂ and Tᵢ^{(mdl)}=0 (block 714), then control returns to block 612 of FIG. 7. If, at block 714, control determines that RSSIᵢ<T₂ and Tᵢ^{(mdl)}=1, then control proceeds to block 618 of FIG. 6.

FIG. 8 is a flowchart representative of example machine readable instructions and/or example operations that may be executed, instantiated, and/or performed by programmable circuitry to implement block 620 of FIG. 6 to execute a repointing algorithm (e.g., a first repointing algorithm, a radiation pattern-cut riding (RPCR) algorithm) to cause the pointing offset of the beam pointing angle of the MDL antenna 116 from the antenna boresight 121 to satisfy a link margin angle θ_{mrg} to facilitate alignment or substantial alignment between the gimbaled antenna 116 and the mission ground station antenna 104 and maximize power reception at the mission ground station antenna 104, or at least to secure that the received power exceeds the RSSI threshold value T₁ (i.e., RSSIᵢ>T₁). FIG. 8 can be performed for one azimuth angle φᵢ associated with the space vehicle 110 at a first and can be repeated for another azimuth angle φᵢ₊₁ associated with the space vehicle 110 at a later time (e.g., in steps of 360° divided by 3 dB beamwidth defined by the MDL antenna diameter, shape, and frequency of operation), as disclosed below.

At block 800, in response to determining that the link margin angle θ_{mrg} is not satisfied when the beam of the MDL antenna 116 is at the first pointing angle (i.e., because RSSIᵢ<T₁), the antenna repointing circuitry 224 generates instructions to cause a beam pointing angle of the MDL antenna 116 to be adjusted by a first pointing angle adjustment step Δ\hat{θ}ᵢ at block 800. In some examples, MDL antenna 116 is controlled by the antenna pointing mechanism 228. In some examples, changes to the beam pointing angle of the MDL antenna 116 result from changes in the attitude of the space vehicle 110 as controlled by the GNC circuitry 205 or from satellite location estimation error due to, for example, lack of GPS and using orbit propagation, for example, in LEO mission. The first pointing adjustment step Δ\hat{θ}ᵢ can be determined based on the antenna pointing rule(s) 231 or based on a prior iteration of the example operations 620 of FIG. 8.

At block 802, the power analysis circuitry 226 uses (a) the RSSIᵢ value for signals received by the mission ground station antenna 104 at a first time i (e.g., after the pointing angle of the MDL antenna 116 has been adjusted by the first pointing angle adjustment step Δ\hat{θ}ᵢ) and (b) an RSSIᵢ₋₁ value for signals received by the mission ground station antenna 104 at a second time i−1 preceding the first time i to determine a differential RSSI value ΔRSSIᵢ, as disclosed in connection with FIGS. 4A-4F.

At block 804, the power analysis circuitry 226 determines, based on the power analysis rule(s) 234 and the differential RSSI value ΔRSSIᵢ, a steepness of a slope of a portion of the radiation pattern for the mission ground station antenna 104 and a sign associated with the slope, namely, ascending or descending.

At block 806, the power analysis circuitry 226 uses the rule(s) 234 defined in, for example, Table 1, above, to analyze the slope patterns and to determine whether, for instance, the slope patterns are indicative of traversing a lobe of the radiation pattern, traversing a peak, approaching a peak, etc. and, thus, indicative of achieving or nearing peak power reception at the mission ground station antenna 104.

At block 808, the power analysis circuitry 226 determines if, based on the RSSI analysis, the power threshold T₁ has been exceeded or not (e.g., RSSI>T₁). The power analysis circuitry 226 outputs an indicator of whether repointing of the MDL antenna 116 should continue or stop (i.e., CtR or SpR) based on the RSSI analysis relative to the power threshold T₁. In some examples, the power analysis circuitry 226 outputs an indicator that repointing of the MDL antenna 116 can stop when the received power exceeds the power threshold T₁ (e.g., RSSI>T₁) In some examples, even if the power threshold T₁ is exceeded, the power analysis circuitry 226 continues to perform RSSI analysis to identify the position of the beam pointing angle when peak power peak power reception by the mission ground station antenna 104 is achieved (e.g., for obtaining a maximum possible link margin). In such examples, the power analysis circuitry 226 outputs the indicator that repointing can stop when the pointing angle associated with peak power has been identified.

If, at block 808, the power analysis circuitry 226 determines that the power threshold T₁ has been exceeded (i.e., the indicator corresponds to stop repointing (SpR)), then control proceeds to block 622 for continued monitoring while the beam of the gimbaled antenna 116 is at the pointing angle θ resulting from the adjustment by the first pointing angle adjustment step Δ\hat{θ}ᵢ.

If, at block 808, the power analysis circuitry 226 determines that the power threshold T₁ has not been exceeded, then control proceeds to block 810, at which the antenna repointing circuitry 224 determines another pointing angle adjustment step Δ\hat{θ}ᵢ₊₁. If after performing adjustments (e.g., all possible adjustments) of an elevation angle θ for the space vehicle 110 (where the elevation angle refers to elevation of the space vehicle above ground, where ground is 0°), the received power does not exceed the threshold T₁ for any elevation angle θ₁, then the antenna repointing circuitry 224 adjusts the azimuth angle (φ₊₁=φᵢ+Δφ) and repeats blocks 802-808 of FIG. 8 (e.g., in steps of 360° divided by 3 dB beamwidth defined by MDL antenna diameter, shape and frequency of operation). The azimuth adjustment step Δφ can be preset and constant each time or vary depending on the distance of the peak power Pₖᵢ found at azimuth angle φᵢ from the threshold T₁ (i.e., Δφ∝|T₁−Pₖᵢ|⇒φᵢ₊₁=φᵢ+Δφ(Pₖᵢ)). For example, the antenna repointing circuitry 224 repeats the RPCR algorithm 400 of FIGS. 4A-4F for another azimuth angle (φᵢ₊₁=φᵢ+Δφ) associated with a radiation pattern cut (e.g., to move from slice to slice of the radiation pattern cut by changing the azimuth angle φᵢ using φᵢ₊₁=φᵢ+Δφ. For example, the antenna repointing circuitry 224 analyzes the steepness of the slope and whether the slope is ascending or descending to determine an amount by which to adjust the pointing angle, as disclosed in connection with FIG. 4F.

At block 812, the antenna repointing circuitry 224 generates instructions to cause a beam pointing angle of the MDL antenna 116 to be adjusted based on the pointing angle adjustment step Δ\hat{θ}ᵢ₊₁ (e.g., via the antenna pointing mechanism 228, via instructions to the GNC circuitry 205 to adjust the attitude of the space vehicle 110). Control returns to block 802 to evaluate whether the power threshold T₁ has been exceeded in connection with the most recent pointing angle adjustment. The antenna repointing circuitry 224 continues to execute the RPCR algorithm until the power threshold T₁ is exceeded. In the event that the power threshold T₁ is never exceeded, the RPCR algorithm 400 will seek to adjust the pointing of the MDL antenna 116 so that the power P_{Rx} received by the mission ground station antenna 104 is maximized but below the threshold T₁.

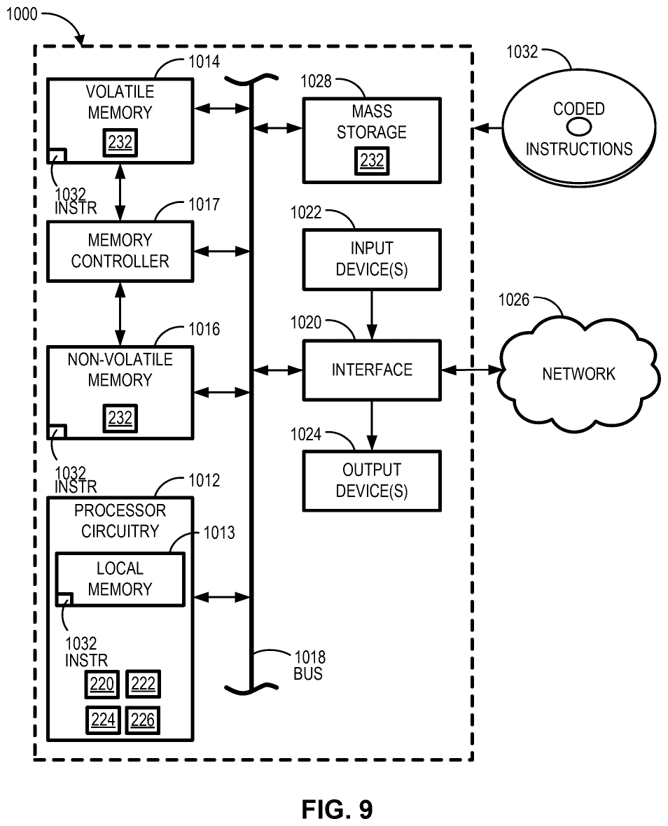

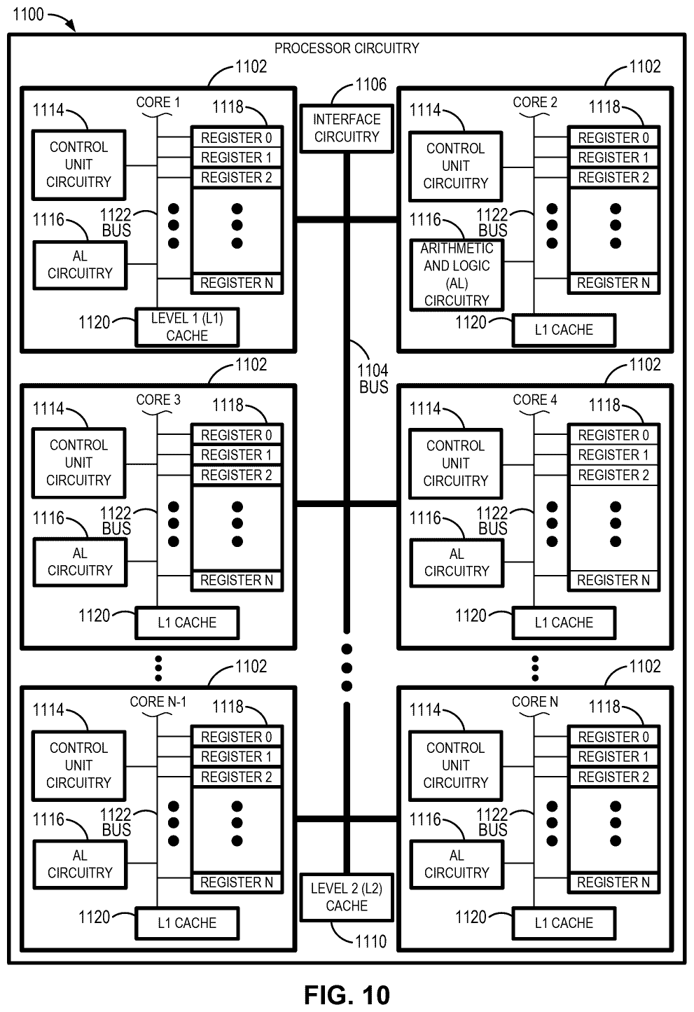

The flowchart(s) of FIGS. 6-8 are representative of example machine readable instructions, which may be executed by programmable circuitry to implement and/or instantiate the antenna pointing control circuitry 124 of FIG. 2 and/or representative of example operations which may be performed by programmable circuitry to implement and/or instantiate the antenna pointing control circuitry 124 of FIG. 2. The machine readable instructions may be one or more executable programs or portion(s) of one or more executable programs for execution by programmable circuitry such as the programmable circuitry 1012 shown in the example processor platform 1000 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-8, many other methods of implementing the example antenna pointing control circuitry 124 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a block diagram of an example programmable circuitry platform 1000 structured to execute and/or instantiate the example machine-readable instructions and/or the example operations of FIGS. 6-8 to implement the antenna pointing control circuitry 124 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example telemetry detection circuitry 220, the example RSSI comparator circuitry 222, the example antenna repointing circuitry 224, and the example power analysis circuitry 226.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 6-8, may be stored in the mass storage device 1028, in the volatile memory 1014, in the non-volatile memory 1016, and/or on at least one non-transitory computer readable storage medium such as a CD or DVD which may be removable.

FIG. 10 is a block diagram of an example implementation of the programmable circuitry 1012 of FIG. 9. In this example, the programmable circuitry 1012 of FIG. 9 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 6-8 to effectively instantiate the circuitry of FIG. 2 as logic circuits to perform operations corresponding to those machine readable instructions. In some such examples, the circuitry of FIG. 2 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 6-8.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 10. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

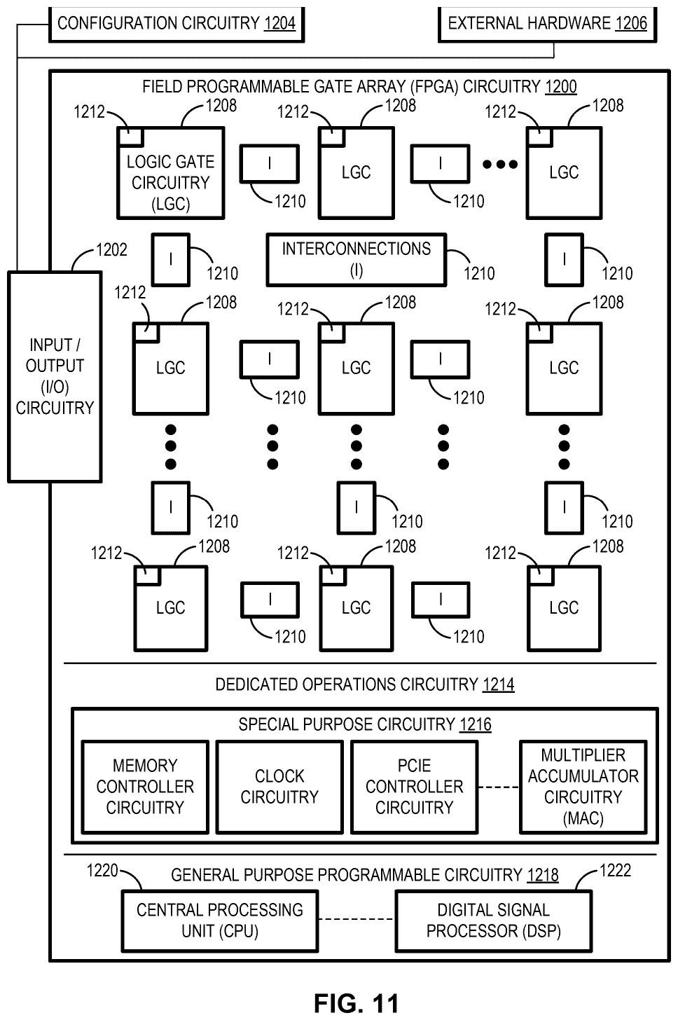

FIG. 11 is a block diagram of another example implementation of the programmable circuitry 1012 of FIG. 9. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 10 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 10 described above (which is a general purpose device that may be programmed to execute some or all of the machine readable instructions represented by the flowchart(s) of FIGS. 6-8 but whose interconnections and logic circuitry are fixed once fabricated), the FPGA circuitry 1200 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-8. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-8. As such, the FPGA circuitry 1200 may be configured and/or structured to effectively instantiate some or all of the operations/functions corresponding to the machine readable instructions of the flowchart(s) of FIGS. 6-8 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 6-8 faster than the general-purpose microprocessor can execute the same.

In the example of FIG. 11, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 11 may access and/or load the binary file to cause the FPGA circuitry 1200 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 11 to cause configuration and/or structuring of the FPGA circuitry 1200 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 11 may access and/or load the binary file to cause the FPGA circuitry 1200 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 11 to cause configuration and/or structuring of the FPGA circuitry 1200 of FIG. 11, or portion(s) thereof.

The FPGA circuitry 1200 of FIG. 11, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 10.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 6-8 and/or other desired operations. The logic gate circuitry 1208 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 11 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 9, many other approaches are contemplated. For example, FPGA circuitry may include an on-board CPU, such as one or more of the example CPU 1220 of FIG. 10. Therefore, the programmable circuitry 1012 of FIG. 9 may additionally be implemented by combining at least the example microprocessor 1100 of FIG. 10 and the example FPGA circuitry 1200 of FIG. 11. In some such hybrid examples, one or more cores 1102 of FIG. 10 may execute a first portion of the machine readable instructions represented by the flowchart(s) of FIGS. 6-8 to perform first operation(s)/function(s), the FPGA circuitry 1200 of FIG. 11 may be configured and/or structured to perform second operation(s)/function(s) corresponding to a second portion of the machine readable instructions represented by the flowcharts of FIGS. 6-8, and/or an ASIC may be configured and/or structured to perform third operation(s)/function(s) corresponding to a third portion of the machine readable instructions represented by the flowcharts of FIGS. 6-8.

It should be understood that some or all of the circuitry of FIG. 2 may, thus, be instantiated at the same or different times. For example, same and/or different portion(s) of the microprocessor 1100 of FIG. 10 may be programmed to execute portion(s) of machine-readable instructions at the same and/or different times. In some examples, same and/or different portion(s) of the FPGA circuitry 1200 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 10 may execute machine readable instructions in one or more threads executing concurrently and/or in series. In some examples, the FPGA circuitry 1200 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 10.

In some examples, the programmable circuitry 1012 of FIG. 9 may be in one or more packages. For example, the microprocessor 1100 of FIG. 10 and/or the FPGA circuitry 1200 of FIG. 11 may be in one or more packages. In some examples, an XPU may be implemented by the programmable circuitry 1012 of FIG. 9, which may be in one or more packages. For example, the XPU may include a CPU (e.g., the microprocessor 1100 of FIG. 10, the CPU 1220 of FIG. 11, etc.) in one package, a DSP (e.g., the DSP 1222 of FIG. 11) in another package, a GPU in yet another package, and an FPGA (e.g., the FPGA circuitry 1200 of FIG. 11) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that control a pointing angle of an antenna of a space vehicle based on analysis of telemetry data received by a TTC antenna at the ground and signal strength for signals received at another ground antenna from the space vehicle antenna. Examples disclosed herein use the telemetry data indicative of a transmission status of the space vehicle antenna and the signal strength analysis, taking into account physical fluctuations of space to ground signal power, to determine whether the pointing angle of the space vehicle antenna should be adjusted to align or substantially align the beam pointing angle of the space vehicle antenna with a boresight of the space vehicle antenna. As a result, examples disclosed herein facilitate alignment between the space vehicle antenna and the ground antenna. Examples disclosed herein can further identify violations of spectrum management policies or instances of interference or hacking based on the analyses. As a result, examples disclosed herein provide for efficient management of a space vehicle antenna using a closed control loop system to facilitate peak power reception at the ground antenna.

Example systems, apparatus, and methods to provide for antenna pointing are disclosed herein. Further examples and combinations thereof include the following:

Example 1 includes an apparatus comprising memory; machine-readable instructions; and at least one processor circuit to be programmed by the machine-readable instructions to identify a transmission status of an antenna of a space vehicle based on telemetry data received from the space vehicle via a first ground antenna; identify a first signal strength value associated with first signals received at a second ground antenna, the first signals transmitted by the antenna of the space vehicle when a beam of the antenna of the space vehicle is at a first pointing angle; responsive to the transmission status and the first signal strength value, determine a pointing angle adjustment step to adjust the first pointing angle relative to the second ground antenna; and cause the first pointing angle to be adjusted to a second pointing angle based on the pointing angle adjustment step.

Example 2 includes the apparatus of example 1, wherein one or more of the at least one processor circuit is to perform a comparison of the first signal strength value to a first power threshold; determine, based on the comparison, that the first signal strength value is less than the first power threshold; and identify, based on the transmission status and the comparison, a first system state, the first system state indicative of a first pointing offset between a boresight axis of the antenna and a line of sight between the antenna of the space vehicle and the second ground antenna.

Example 3 includes the apparatus of examples 1 or 2, wherein one or more of the at least one processor circuit is to determine a difference in signal strength values based on the first signal strength value and a second signal strength value, the second signal strength value associated with second signals received at the second ground antenna, the second signals transmitted by the antenna of the space vehicle when the beam of the antenna of the space vehicle is at a pointing angle different than the first pointing angle; and determine the pointing angle adjustment step based on the difference in signal strength value.

Example 4 includes the apparatus of any of examples 1-3, wherein the point angle adjustment step is a first pointing angle adjustment step and one or more of the at least one processor circuit is to identify a second signal strength value of second signals received at the second ground antenna, the second signals transmitted by the antenna of the space vehicle when the beam of the antenna of the space vehicle is at the second pointing angle; determine that the second signal strength value does not satisfy a first power threshold; and determine a second pointing angle adjustment step responsive to the determination that the second signal strength value does not satisfy the first power threshold.

Example 5 includes the apparatus of any of examples 1-4, wherein one or more of the at least one processor circuit is to determine the pointing angle adjustment step based on a property of a slope of a lobe of a radiation pattern for the second ground antenna, the property of the slope associated with one or more of an azimuth angle or an elevation angle of the space vehicle at a first time.

Example 6 includes the apparatus of any of examples 1-5, wherein the antenna is a patch antenna and the one or more of the at least one processor circuit is to output an instruction to cause an attitude of the space vehicle to be adjusted to cause the first pointing angle to be adjusted.

Example 7 includes the apparatus of any of examples 1-6, wherein the antenna is moveable via a gimbal or electrically steerable.

Example 8 includes a non-transitory machine readable storage medium comprising instructions to cause at least one processor circuit to at least identify, based on a transmission status of an antenna of a space vehicle and a signal strength value, a system state as a first system state or a second system state, the signal strength value associated with signals received by a receiver associated with a ground antenna, the signals transmitted by the antenna of the space vehicle when a pointing angle of a beam of the antenna of the space vehicle is at a first pointing angle; when the system state is the first system state, maintain the pointing angle at the first pointing angle; and when the system state is the second system state, cause the pointing angle to be adjusted from the first pointing angle to a second pointing angle.

Example 9 includes the non-transitory machine readable storage medium of example 8, wherein the ground antenna is a first ground antenna, the antenna of the space vehicle is a first antenna, and the machine-readable instructions are to cause one or more of the at least one processor circuit to identify the transmission status of the first antenna based on telemetry data transmitted by a second antenna of the space vehicle and received by a second ground antenna.

Example 10 includes the non-transitory machine readable storage medium of examples 8 or 9, wherein the machine-readable instructions are to cause one or more of the at least one processor circuit to identify, based on the transmission status and the signal strength value, that the system state is a third system state, the third system state different than the first system state and the second system state; and cause the receiver associated with the ground antenna to enter an idle state in response to identifying the system state as the third system state.

Example 11 includes the non-transitory machine readable storage medium of any of examples 8-10, wherein the machine-readable instructions are to cause one or more of the at least one processor circuit to cause the receiver associated with the ground antenna to enter the idle state in response to identifying that the system state is a fourth system state, the fourth system state indicative of interference.

Example 12 includes the non-transitory machine readable storage medium of any of examples 8-11, wherein the machine-readable instructions are to cause one or more of the at least one processor circuit to identify that the system state is in the fourth system state based on the transmission status and the signal strength value exceeding a first power threshold.

Example 13 includes the non-transitory machine readable storage medium of any of examples 8-12, wherein the machine-readable instructions are to cause one or more of the at least one processor circuit to detect hacking in response to the identification that the system state is in the fourth system state and based on an authentication analysis of a message received by the ground antenna.

Example 14 includes the non-transitory machine readable storage medium of any of examples 8-13, wherein the machine-readable instructions are to cause one or more of the at least one processor circuit to determine that the signal strength value fails to satisfy a first power threshold; responsive to determining that the signal strength value failing to satisfy the first power threshold, determine that a pointing offset between a boresight of the antenna of the space vehicle and a line of sight between the antenna of the space vehicle and the ground antenna fails to satisfy a first angular threshold; and identify the system state as the second system state based on the pointing offset failing to satisfy the first angular threshold.

Example 15 includes the non-transitory machine readable storage medium of any of examples 8-14, wherein the machine-readable instructions are to cause one or more of the at least one processor circuit to execute, based on the signal strength value, a first repointing operation to determine an adjustment step to cause the pointing angle to be adjusted from the first pointing angle to the second pointing angle.

Example 16 includes a system comprising a first antenna located at ground; a second antenna located at the ground; a third antenna, the third antenna carried by a space vehicle; a fourth antenna carried by the space vehicle; machine-readable instructions; and at least one processor circuit to be programmed by the machine-readable instructions to determine, based on first signals transmitted by the third antenna and received at the first antenna and second signals transmitted by the fourth antenna and received at the second antenna, that a pointing offset of a beam pointing angle of the third antenna from a boresight axis associated with the third antenna fails to satisfy a first angular threshold; and responsive to the pointing offset failing to satisfy the first angular threshold, cause the beam pointing angle of the third antenna to change.

Example 17 includes the system of example 16, wherein the first signals correspond to telemetry data indicative of a transmission status of the third antenna, the telemetry data transmitted by the fourth antenna.

Example 18 includes the system of examples 16 or 17, wherein the fourth antenna is associated with a hemispherical radiation pattern.

Example 19 includes the system of any of examples 16-18, wherein the third antenna is supported by a moveable gimbal.

Example 20 includes the system of any of examples 16-19, wherein the third antenna is a patch antenna, and one or more of the at least one processor circuit is to communicate with guidance, navigation, and control circuitry of the space vehicle to cause the beam pointing angle of the patch antenna to change via an adjustment to an attitude of the space vehicle.

Example 21 includes the system of any of examples 16-20, wherein the one or more of the at least one processor circuit is to determine a Received Signal Strength Indicator for the second signals; and determine, based on the Received Signal Strength Indicator for the second signals, an adjustment step to change the beam pointing angle of the third antenna.

Example 22 includes the system of any of examples 16-21, wherein one or more of the at least one processor circuit is to determine the Received Signal Strength Indicator via the first antenna, the first antenna located at ground.

Example 23 includes the system of any of examples 16-22, wherein one or more of the at least one processor circuit is to determine the adjustment step at ground and transmit the adjustment step to the space vehicle via the second antenna.

Example 24 includes the system of any of examples 16-23, wherein one or more of the at least one processor circuit is to transmit the Received Signal Strength Indicator to the space vehicle.

Example 25 includes the system of any of examples 16-24, wherein one or more of the at least one processor circuit is to determine the adjustment step at the space vehicle.

Example 26 includes the system of any of examples 16-25, wherein the third antenna is communicatively coupled to a transceiver and one or more of the at least one processor circuit is to determine the Received Signal Strength Indicator at the space vehicle.

Example 27 includes the system of any of examples 16-26, wherein one or more of the at least one processor circuit is to determine the adjustment step at the space vehicle.

Example 28 includes the system of any of examples 16-27, wherein one or more of the at least one processor circuit is to further determine the Received Signal Strength Indicator at ground.

Example 29 includes the system of any of examples 16-28, wherein one or more of the at least one processor circuit is to cause the beam pointing angle of the third antenna to change from a first beam pointing angle to a second beam pointing angle; determine a power level associated with third signals received at the second antenna and transmitted by the third antenna when the beam pointing angle of the third antenna is at second beam pointing angle; perform a comparison of the power level to a first power threshold; and based on the comparison, determine an amount by which to change the beam pointing angle of the third antenna from the second beam pointing angle to a third beam pointing angle.

Example 30 includes the system of any of examples 16-29, wherein one or more of the at least one processor circuit is to determine an amount by which to change the beam pointing angle to cause the power level to exceed the first power threshold.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
memory;
machine-readable instructions; and
at least one processor circuit to be programmed by the machine-readable instructions to:
identify a transmission status of an antenna of a space vehicle based on telemetry data received from the space vehicle via a first ground antenna;
identify a first signal strength value associated with first signals received at a second ground antenna, the first signals transmitted by the antenna of the space vehicle when a beam of the antenna of the space vehicle is at a first pointing angle;
responsive to the transmission status and the first signal strength value, determine a pointing angle adjustment step to adjust the first pointing angle relative to the second ground antenna; and
cause the first pointing angle to be adjusted to a second pointing angle based on the pointing angle adjustment step.

2. The apparatus of claim 1, wherein one or more of the at least one processor circuit is to:
perform a comparison of the first signal strength value to a first power threshold;
determine, based on the comparison, that the first signal strength value is less than the first power threshold; and
identify, based on the transmission status and the comparison, a first system state, the first system state indicative of a first pointing offset between a boresight axis of the antenna and a line of sight between the antenna of the space vehicle and the second ground antenna.

3. The apparatus of claim 1, wherein one or more of the at least one processor circuit is to:
determine a difference in signal strength values based on the first signal strength value and a second signal strength value, the second signal strength value associated with second signals received at the second ground antenna, the second signals transmitted by the antenna of the space vehicle when the beam of the antenna of the space vehicle is at a pointing angle different than the first pointing angle; and
determine the pointing angle adjustment step based on the difference in signal strength value.

4. The apparatus of claim 1, wherein the point angle adjustment step is a first pointing angle adjustment step and one or more of the at least one processor circuit is to:
identify a second signal strength value of second signals received at the second ground antenna, the second signals transmitted by the antenna of the space vehicle when the beam of the antenna of the space vehicle is at the second pointing angle;
determine that the second signal strength value does not satisfy a first power threshold; and
determine a second pointing angle adjustment step responsive to the determination that the second signal strength value does not satisfy the first power threshold.

5. The apparatus of claim 1, wherein one or more of the at least one processor circuit is to determine the pointing angle adjustment step based on a property of a slope of a lobe of a radiation pattern for the second ground antenna, the property of the slope associated with one or more of an azimuth angle or an elevation angle of the space vehicle at a first time.

6. The apparatus of claim 1, wherein the antenna is a patch antenna and the one or more of the at least one processor circuit is to output an instruction to cause an attitude of the space vehicle to be adjusted to cause the first pointing angle to be adjusted.

7. The apparatus of claim 1, wherein the antenna is moveable via a gimbal or electrically steerable.

8. A non-transitory machine readable storage medium comprising instructions to cause at least one processor circuit to at least:
identify, based on a transmission status of an antenna of a space vehicle and a signal strength value, a system state as a first system state or a second system state, the signal strength value associated with signals received by a receiver associated with a ground antenna, the signals transmitted by the antenna of the space vehicle when a pointing angle of a beam of the antenna of the space vehicle is at a first pointing angle;
when the system state is the first system state, maintain the pointing angle at the first pointing angle; and
when the system state is the second system state, cause the pointing angle to be adjusted from the first pointing angle to a second pointing angle.

9. The non-transitory machine readable storage medium of claim 8, wherein the ground antenna is a first ground antenna, the antenna of the space vehicle is a first antenna, and the machine-readable instructions are to cause one or more of the at least one processor circuit to identify the transmission status of the first antenna based on telemetry data transmitted by a second antenna of the space vehicle and received by a second ground antenna.

10. The non-transitory machine readable storage medium of claim 8, wherein the machine-readable instructions are to cause one or more of the at least one processor circuit to:
identify, based on the transmission status and the signal strength value, that the system state is a third system state, the third system state different than the first system state and the second system state; and
cause the receiver associated with the ground antenna to enter an idle state in response to identifying the system state as the third system state.

11. The non-transitory machine readable storage medium of claim 10, wherein the machine-readable instructions are to cause one or more of the at least one processor circuit to cause the receiver associated with the ground antenna to enter the idle state in response to identifying that the system state is a fourth system state, the fourth system state indicative of interference.

12. The non-transitory machine readable storage medium of claim 11, wherein the machine-readable instructions are to cause one or more of the at least one processor circuit to identify that the system state is in the fourth system state based on the transmission status and the signal strength value exceeding a first power threshold.

13. The non-transitory machine readable storage medium of claim 11, wherein the machine-readable instructions are to cause one or more of the at least one processor circuit to detect hacking in response to the identification that the system state is in the fourth system state and based on an authentication analysis of a message received by the ground antenna.

14. The non-transitory machine readable storage medium of claim 8, wherein the machine-readable instructions are to cause one or more of the at least one processor circuit to:
determine that the signal strength value fails to satisfy a first power threshold;
responsive to determining that the signal strength value failing to satisfy the first power threshold, determine that a pointing offset between a boresight of the antenna of the space vehicle and a line of sight between the antenna of the space vehicle and the ground antenna fails to satisfy a first angular threshold; and
identify the system state as the second system state based on the pointing offset failing to satisfy the first angular threshold.

15. The non-transitory machine readable storage medium of claim 14, wherein the machine-readable instructions are to cause one or more of the at least one processor circuit to execute, based on the signal strength value, a first repointing operation to determine an adjustment step to cause the pointing angle to be adjusted from the first pointing angle to the second pointing angle.

16. A system comprising:
a first antenna located at ground;
a second antenna located at the ground;
a third antenna, the third antenna carried by a space vehicle;
a fourth antenna carried by the space vehicle;
machine-readable instructions; and
at least one processor circuit to be programmed by the machine-readable instructions to:
determine, based on first signals transmitted by the third antenna and received at the first antenna and second signals transmitted by the fourth antenna and received at the second antenna, that a pointing offset of a beam pointing angle of the third antenna from a boresight axis associated with the third antenna fails to satisfy a first angular threshold; and
responsive to the pointing offset failing to satisfy the first angular threshold, cause the beam pointing angle of the third antenna to change.

17. The system of claim 16, wherein the first signals correspond to telemetry data indicative of a transmission status of the third antenna, the telemetry data transmitted by the fourth antenna.

18. (canceled)

19. The system of claim 16, wherein the third antenna is supported by a moveable gimbal.

20. The system of claim 16, wherein the third antenna is a patch antenna, and one or more of the at least one processor circuit is to communicate with guidance, navigation, and control circuitry of the space vehicle to cause the beam pointing angle of the patch antenna to change via an adjustment to an attitude of the space vehicle.

21. The system of claim 16, wherein the one or more of the at least one processor circuit is to:
determine a Received Signal Strength Indicator for the second signals; and
determine, based on the Received Signal Strength Indicator for the second signals, an adjustment step to change the beam pointing angle of the third antenna.

22.-30. (canceled)
